(19) United States
(12) Patent Application Publication
(10) Pub. No.: US 2008/0137229 A1
(43) Pub. Date: Jun. 12, 2008

(54) HYDRODYNAMIC BEARING DEVICE, SPINDLE MOTOR INCLUDING THE SAME, AND INFORMATION RECORDING AND REPRODUCING APPARATUS

(76) Inventors: Junichi Nakamura, Ehime (JP); Kaoru Uenosono, Ehime (JP); Toshifumi Hino, Ehime (JP)

Correspondence Address: WENDEROTH, LIND & PONACK L.L.P., 2033 K. STREET, NW, SUITE 800, WASHINGTON, DC, 20006, US

(21) Appl. No.: 11/948,432

(22) Filed: Nov. 30, 2007

(30) Foreign Application Priority Data
Dec. 1, 2006 (JP) 2006-325196

(51) Int. Cl. F16C 32/06; H02K 7/08; G11B 17/02

(52) U.S. Cl. 360/99.08; 384/107; 310/90

(57) ABSTRACT

A hydrodynamic bearing device which can enhance operating efficiency of a step of filling a lubricant and also effectively suppress leakage of the lubricant to an outer peripheral portion of the hydrodynamic bearing device; a spindle motor including the same; and an information recording and reproducing apparatus are provided

A hydrodynamic bearing device includes a sleeve, a shaft, a lubricant, a plurality of lube repellent application areas, and a lube repellent non-application area. The sleeve has an insertion hole as a bearing hole on at least one end. The shaft is inserted into the insertion hole of the sleeve and is supported so as to be relatively rotatable with respect to the sleeve. The lubricant is interposed in a clearance between the sleeve and the shaft. The plurality of lube repellent application areas are formed into a circular pattern with the shaft being a substantial center on at positions outside the insertion hole of an open upper surface of the sleeve in a radial direction of the shaft. The lube repellent non-application area is formed between two of the lube repellent application areas which are adjacent to each other.

### BACKGROUND OF THE INVENTION

1. Field of the Invention

The present invention relates to a hydrodynamic bearing device used for an information recording and reproducing apparatus such as a hard disc apparatus or the like, a spindle motor including such a hydrodynamic bearing device, and an information recording and reproducing apparatus including such a spindle motor.

2. Description of the Related Art

In recent years, it is becoming more popular to use a hydrodynamic bearing device in bearing portions of the spindle motors used in information recording and reproducing apparatuses such as hard disc drives and the like. The hydrodynamic bearing device is a bearing device which includes a lubricant such as oil interposed between a shaft and a sleeve for using a fluid pressure generated by the lubricant as a supporting force. In order to operate such a device with a high precision, it is important to prevent leakage and/or evaporation of the lubricant.

Generally, in such a hydrodynamic bearing device, an lube repellent is applied near an open end in order to prevent the lubricant from being leaked or oozing out of the open end.

FIG. 11 shows an exemplary motor for a hard disc drive which incorporates a spindle motor including a hydrodynamic bearing device. The spindle motor includes a sleeve 901 having an insertion hole in the central portion, and a shaft 903 which rotates relative to the sleeve 901 and is inserted into the insertion hole with a predetermined clearance being interposed therebetween. A lubricant 904 is filled in the clearance between the shaft 903 and the sleeve 901. A bearing seal portion 921 is provided between the insertion hole and the shaft 903. The bearing seal portion 921 is formed of a clearance becoming wider toward outside the bearing, and seals the lubricant 904 in the bearing portion by utilizing a surface tension of the lubricant 904 itself. A hub 920 is attached to a portion of the shaft 903 which protrudes above the sleeve 901. A magnetic disc 917 is fixed to the hub 920 with a clamper 934. The clamper 934 is fixed to an upper portion of the hub 920 by threading a screw 933 onto a threaded hole 907 provided at a tip portion of the shaft 903.

On at least one of an outer peripheral surface of the shaft 903 and an inner peripheral surface of the sleeve 901, a radial bearing portion 923 is formed. The radial bearing portion 923 includes hydrodynamic grooves (not shown) having a herringbone pattern or the like. To a lower of the shaft 903, a thrust flange 910 is fixed. To a lower end of the sleeve 901, a thrust plate 911 is fixed to close the lower end of the sleeve 901. On at least one of the thrust plate 911 and the thrust flange 910, and on at least one of the thrust flange 910 and the sleeve 901, thrust bearing portions 924 are formed. Similarly to the radial bearing portion 923, the thrust bearing portions 924 include hydrodynamic grooves. In order to prevent the fluid lubricant 904 from being leaked out of an upper end of the sleeve 901, an lube repellent is applied to an open upper surface 902 of the sleeve 901.

When the shaft 903 rotates due to interaction between a rotor magnet 926 and a stator 925, a pressure is generated in the lubricant 904 by the hydrodynamic grooves of the radial bearing portion 923 and the thrust bearing portions 924. The shaft 903 is supported so as to be rotatable with respect to the sleeve 901 with a certain clearance interposed therebetween.

There have been a plurality proposals regarding application of an lube repellent near an open end of a bearing in such a bearing device having the above-described structure.

For example, in one structure, an lube repellent 905 is applied entirely across an open upper surface 902 of a sleeve 901 (see Japanese Laid-Open Publication Nos. 2001-304263 and 2004-263814).

Meanwhile, hard disc drives are becoming thinner. This causes a length of a portion of a tip portion of a shaft 903 which is used for connecting a hub 920 to become shorter. As a result, a length of a portion of the shaft 903 which protrudes above the open upper surface 902 of the sleeve 901 becomes shorter. Also, a diameter of the HDDs is becoming smaller. Thus, an outer diameter of a bearing unit, i.e., an outer diameter of the sleeve 901 is becoming smaller. Accordingly, an area of the open upper surface 902 of the sleeve 901, to which the lube repellent is applied, becomes smaller.

As to a method for filling the lubricant to a hydrodynamic bearing device 930, a vacuum oil filling method which utilizes a pressure difference is widely used. In this method, the bearing unit is first left in vacuum atmosphere, and the lubricant 904 is dropped to the opening or the bearing unit is immersed in the lubricant 904. Then, the entire bearing unit is disposed to the atmospheric pressure to fill the lubricant 904 in the bearing portion.

Specifically, for filling the lubricant, the following steps are performed with a thin dispenser nozzle 916 as shown in FIG. 12A.
(A) A tip of the dispenser nozzle 916 is brought close to the shaft 903 near a bearing seal portion 921 with a caution being taken so that they do not touch each other, and a drop 946 of the lubricant is formed at the tip of the dispenser nozzle 916.
(B) As the size of the drop 946 increases, the drop 946 touches the upper surface of the sleeve.
(C) A pressure is further applied to the drop 946 to increase the size of the drop 946.
(D) When the dispenser nozzle 916 is moved away from the sleeve 901, the drop 946 separates from the tip of the dispenser nozzle 916 due to the weight of itself and a surface tension between the drop 946 and the open upper surface 902.
(E) The drop 946 expands due to the gravity and the surface tension and is supplied near the bearing seal portion 921.

If a diameter of the sleeve is sufficiently large as in 3.5-inch HDDs, even when the lube repellent 905 is applied entirely across the open upper surface 902, the lubricant 904 is adsorbed to an outer peripheral cylindrical surface of the shaft 903 on an inner peripheral side as shown in FIG. 12E. Thus, it can remain on the open upper surface 902. Therefore, by raising a pressure around the bearing unit after the lubricant 904 has been supplied, the lubricant 904 is pushed into the clearance of the bearing portion. Then, an excess lubricant 904 remaining on the open upper surface 902 can be wiped off and the bearing unit is completed.

However, in recent years, the HDDs have been miniaturized. Accordingly, motors and bearing devices used therein have also been miniaturized. For filling the lubricant into such small bearing devices, if the lube repellent 905 is applied entirely across the open upper surface 902 of the sleeve 901 and then the lubricant is dropped and applied to the area where the lube repellent 905 is applied as in the conventional art, the lubricant 904 dropped on the area where the lube repellent 905 is applied is split and move toward inner and outer peripheries. This may cause problems such that the lubricant 904 is not supplied to the bearing opening into which the oil should be filled, or the lubricant 904 attaches to an outer peripheral portion of the hydrodynamic bearing unit.

Specifically, as shown in FIGS. 13A through 13F, what happens in a bearing device having a sleeve 903 of a small diameter in 2.5-inch HDDs and smaller HDDs is significantly different from that in the 3.5-inch HDDs. Steps (A) through (C) are similar to those in the 3.5-inch HDDs. However, as shown in Step (D), since the diameter of the sleeve 903 is small, the drop 946 can no longer be held on the open upper surface 902. This is because the lube repellent 905 is applied entirely across the open upper surface 902. When the drop 946 spreads to the outer periphery of the sleeve 901, a part of the lubricant 904 is attracted toward the outer periphery of the sleeve 901 as shown in Step (E) since the lube repellent is not applied to the outer peripheral portion. Then, the lubricant 904 is split and move to the inner and outer peripheries of the sleeve 901 as shown in Step (F).

As a result, a sufficient amount of the lubricant 904 may not be supplied to the radial bearing portion 923 or the thrust bearing portions 924, causing a lack of lubrication, and/or the lubricant 904 may attach to the outer periphery of the sleeve 901. Since the outer peripheral portion of the bearing unit is usually used for adhesion to a base member which forms an HDD, the lubricant 904 attached to this portion deteriorates adhesive strength. Thus, a step for removing the lubricant 904 is further required. This may cause problems such that the whole operation becomes complicated, the cost increases, and the adhesive strength deteriorates due to a residue of the lubricant 904.

In order to prevent the drop 946 from being split toward the inner and outer peripheries, the size of the supplied drop 946 may be reduced. However, this is difficult in practice. After the drop 946 is formed at the tip of the dispenser nozzle 916, for removing only the dispenser nozzle 916 with the drop 946 being supplied on the sleeve 901, the weight of the drop 946 itself plus the adsorption force between the drop 946 and the sleeve 901/shaft 903 has to be larger than the adsorption force of the drop 946 to the dispenser nozzle 916 which is generated by the surface tension of the drop 946. However, unless the specifications of the dispenser nozzle 916 do not change, magnitude relation between the adsorption forces does not change basically. For reducing the size of the drop 946, it is most effective to reduce the diameter of the dispenser nozzle 916. However, when the diameter of the dispenser nozzle 916 is reduced, an influence of the viscosity of the lubricant 904 causes a great influence. It becomes difficult to supply a sufficient amount of the lubricant 904 from the dispenser nozzle 916.

Furthermore, even if a drop 946 of a small size can be formed at the tip of a thin dispenser nozzle 916, the drop 946 sometimes cannot be supplied to the sleeve 901. When the lube repellent 905 is applied on the upper surface of the sleeve 901 as shown in FIG. 14A, even if the drop 946 once touches the open upper surface 902 as shown in FIG. 14B, the drop 946 remains adsorbed to the dispenser nozzle 916 and is moved away from the open upper surface 902 as the dispenser nozzle 916 is moved away as shown in FIG. 14C. Therefore, even when the diameter of the dispenser nozzle 916 is reduced, the drop 946 cannot be adsorbed to the sleeve 901 if the weight of the drop 946 itself and the area on which it touches the sleeve 901 are not sufficiently large, and the lubricant 904 cannot be supplied.

Another method may be considered with the highest priority being given to supplying the lubricant 904. As shown in FIGS. 15A through 15E, the step of applying the lube repellent 905 to the open upper surface 902 is deferred and the lube repellent 905 is applied after the lubricant 904 is supplied. However, since the lube repellent 905 is applied after the lubricant 904 is filled, the lube repellent 905 may enter the bearing seal portion 921 and fall the bearing sealing function, and/or the lube repellent 905 may enter the radial bearing portion and cause seizure of the bearing due to lack of lubrication. Further, an operation of wiping off an excess lubricant 904 which remains on the open upper surface 902 with no lube repellent 905 being applied to the open upper surface 902 is required. The wiping-off operation is performed by using a vacuum nozzle (not shown), or by sucking with a waste cloth 960 as shown in FIG. 15D. However, as shown in FIG. 15E, the amount of the lubricant 904 may become insufficient because the lubricant is sucked too much.

The drop 946 of the lubricant remaining on the upper surface of the sleeve 901 and the drop 946 inside the bearing seal portion 921 are continuous as shown in FIG. 15D, and the lubricant 904 has a surface tension. Thus, when the drop 946 of the lubricant remaining on the open upper surface 902 is sucked by the waste cloth 960, the lubricant 904 inside the bearing seal portion 921 is sucked together.

As shown in FIGS. 16A through 16F, even if the lube repellent 905 is applied in a circular shape only at the outer peripheral side of the sleeve 901 in order to prevent the lubricant 904 from spilling out of the outer periphery, a phenomenon similar to that indicated by FIGS. 15A through 15F occurs.

An object of the present invention is to provide: a hydrodynamic bearing device which can enhance operating efficiency of a step of filling a lubricant and also effectively suppress leakage of the lubricant to an outer peripheral portion of the hydrodynamic bearing device; a spindle motor including the same; and an information recording and reproducing apparatus.

### SUMMARY OF THE INVENTION

A hydrodynamic bearing device according to the first invention includes a sleeve, a shaft, a lubricant, a plurality of lube repellent application areas, and a lube repellent non-application area. The sleeve has an opening portion as a bearing hole on at least one end. The shaft is inserted into the bearing hole of the sleeve and is supported so as to be relatively rotatable with respect to the sleeve. The lubricant is interposed in a clearance between the sleeve and the shaft. The plurality of lube repellent application areas are formed into a circular pattern with the shaft being a substantial center on at least one of the sleeve and the shaft at positions outside a liquid-gas interface between the lubricant and air in a radial direction or in an axial direction. The lube repellent non-application area is formed between two of the lube repellent application areas which are adjacent to each other.

Here, a plurality of lube repellent application areas are formed into a circular pattern with the shaft being a substantial center on at least one of the sleeve and the shaft at positions outside a liquid-gas interface between the lubricant and air in a radial direction or in an axial direction. Between one lube repellent application area having the shaft as the substantial center and another lube repellent application area having the shaft as the substantial center which is formed at position inside or outside the lube repellent application area, an lube repellent non-application area is formed.

The shaft in such a structure may include a hub which is integral or is attached by fixing (in a shaft-rotary type device), fixed portions such as a base chassis, a motor bracket, a base cover (in a shaft-fixed type device), or the like. The sleeve may include a sleeve cover, a sleeve holder, and further, a base chassis, a motor bracket (in a shaft-rotary type device) or a hub (in a shaft-fixed type device), and so on. The circular pattern of the lube repellent application area does not have to be a perfect circle, but may be an ellipse, or a polygon shape. Further, a plurality of lube repellent non-application areas may be formed.

Conventionally, in the hydrodynamic bearing device, an lube repellent is applied entirely across an upper surface of a sleeve in order to prevent a lubricant from leaking out of bearing portions. In this way, the lubricant is prevented from leaking out of the bearing portions. However, in recent years, the HDDs have been miniaturized. Accordingly, for filling the lubricant into miniaturized bearing devices, if the lubricant is dropped and applied to the open upper surface of the sleeve on which the lube repellent is applied entirely as in the conventional art, the lubricant is split and move toward inner and outer peripheries. This may cause problems such that the lubricant is not supplied to the bearing portion into which the lubricant should be supplied, or the lubricant attaches to an outer peripheral portion of the hydrodynamic bearing device (for example, an outer peripheral surface of the sleeve). Also, since the lubricant easily moves on a surface on which the lube repellent is applied, the lubricant tends to move toward the sleeve outer peripheral surface or the like by vibration of a motor, a centrifugal force, air stream inside the motor or the like once the lubricant spreads over the upper surface of the sleeve where the lube repellent is applied entirely.

Thus, the hydrodynamic bearing device according to the present invention includes a plurality of lube repellent application areas formed into a circular pattern with the shaft being a substantial center on at least one of the sleeve and the shaft at positions outside a liquid-gas interface between the lubricant and air in a radial direction or in an axial direction, and an lube repellent non-application area formed between two of the lube repellent application areas adjacent to each other.

With such a structure, the lubricant dripped onto the sleeve upper surface during the step of supplying the lubricant is repelled at the lube repellent application area. Thus, the lubricant can remain on the lube repellent non-application area formed between the innermost lube repellent application area and the outermost lube repellent application area. Furthermore, the lubricant remaining on the lube repellent non-application area and the lubricant inside the bearing portion can be separated perfectly by the innermost lube repellent application area. Thus, even when the excess lubricant remaining on the sleeve upper surface is wiped off, the lubricant filled inside the bearing portions can be prevented from being wiped off inadvertently. Moreover, even when the lubricant leaks out to the sleeve upper surface, the lubricant can be held on the lube repellent non-application area formed between the lube repellent application areas.

Accordingly, operating efficiency of a step of filling a lubricant can be enhanced, and also leakage of the lubricant to an outer peripheral portion of the hydrodynamic bearing device can be effectively suppressed.

A hydrodynamic bearing device according to the second invention is the hydrodynamic bearing device according to the first invention, in which a surface roughness of the lube repellent non-application area is larger than a surface roughness of the lube repellent application areas.

Here, a surface roughness of the lube repellent non-application area on the sleeve or the shaft is set to be larger than a surface roughness of the lube repellent application areas.

In general, dispersion of the lube repellent is prevented when the surface roughness is large. Thus, by setting the surface roughness of a portion on which the lube repellent application area is to be formed small, the lube repellent can be applied selectively. Wettability of the lubricant increases at the area with large surface roughness such that an apparent contact angle becomes further small. Accordingly, the lubricant can be readily held on the area with large surface roughness, i.e., the lube repellent non-application area.

A hydrodynamic bearing device according to the third invention is the hydrodynamic bearing device according to the first invention, in which the lube repellent application areas are provided near the opening portion of the sleeve and near an outer end portion in the radial direction.

Here, the lube repellent application areas are provided near the opening portion of the sleeve and near an outer end portion in the radial direction.

With such a structure, when the excess lubricant remaining on the sleeve upper surface is removed, the lubricant filled inside the bearing portions can be prevented from being removed by the lube repellent application area provided near the opening portion of the sleeve. Further, when the lubricant is filled, the lubricant can be prevented from flowing out to the outer peripheral surface of the sleeve by the lube repellent application area formed near the outer end portion of the sleeve in the radial direction.

A hydrodynamic bearing device according to the fourth invention is the hydrodynamic bearing device according to first invention, in which the shaft includes a fixed portion which is fixed or integrally formed.

Here, if the hydrodynamic device is of the shaft-rotary type, it includes a hub as a fixed portion which is fixed to or integrally formed with the shaft. If the hydrodynamic bearing device is of the shaft-fixed type, it includes a base chassis or a motor bracket as a fixed portion which is fixed to or integrally formed with the shaft, and also a base cover located above the motor, if both ends of the shaft are fixed.

With such a structure, design flexibility can be enhanced because the lube repellent application areas and the lube repellent non-application area can also be formed on the fixed portions such as hub and the like, for example.

A hydrodynamic bearing device according to the fifth invention is the hydrodynamic bearing device according to the first invention, in which the lube repellent application areas and the lube repellent non-application area are provided on one of the sleeve and the shaft which rotates.

Here, the lube repellent application areas and the lube repellent non-application area are provided on one of the sleeve and the shaft which rotates.

With such a structure, the lubricant which tends to move toward the outer periphery of the rotating member due to the centrifugal force can be stemmed at a border portion between the lube repellent application area and the lube repellent non-application area. Thus, the lubricant can be prevented from dispersing toward the outer periphery of the rotating member.

A hydrodynamic bearing device according to the sixth invention is the hydrodynamic bearing device according to the first invention, in which the lube repellent application areas and the lube repellent non-application area are provided on both of the sleeve and the shaft.

Here, the lube repellent application areas and the lube repellent non-application area are provided on both of the sleeve and the shaft.

With such a structure, dispersion of the lubricant due to a centrifugal force and oozing out of the lubricant due to capillary action can be prevented.

A hydrodynamic bearing device according to the seventh invention is the hydrodynamic bearing device according to the first invention, in which the lube repellent application areas and the lube repellent non-application area are formed on opposing surfaces of the sleeve and the shaft which oppose each other.

Here, the lube repellent application areas and the lube repellent non-application area are formed on opposing surfaces of the sleeve and the shaft which oppose each other. For example, the lube repellent application areas and the lube repellent non-application area are formed on opposing surfaces of a hub and the sleeve which oppose each other, and the hub which is fixed to or integrally formed with the shaft.

With such a structure, the lube repellent application areas and the lube repellent non-application area can be located in a further effective manner.

A hydrodynamic bearing device according to the eighth invention is the hydrodynamic bearing device of the seventh invention, in which the lube repellent non-application area is formed on a surface opposing the lube repellent application areas which is formed on one of the shaft and the sleeve, and the lube repellent non-application area is formed on a surface opposing the lube repellent application areas which is formed on the other of the shaft and the sleeve.

Here, the lube repellent application areas and the lube repellent non-application area are located on the opposing surfaces as described above. For example, when the hub attached to the shaft is located so as to oppose the sleeve, the lube repellent non-application area is formed on the hub at a position opposing the position where the lube repellent application area is formed on the sleeve. Further, the lube repellent application area is formed on the hub at a position opposing the position where the lube repellent non-application area is formed on the sleeve.

By forming at least two lube repellent application areas on one of the hub (shaft) and the sleeve, the lube repellent non-application area can be formed on one of the hub (shaft) and the sleeve.

With such a structure, the lubricant can be maintained at the lube repellent non-application area formed on one of the hub (shaft) and the sleeve. Further, on the lube repellent application area which opposes thereto, wettability of the lubricant is low, and thus, influence of the centrifugal force can be suppressed. Accordingly, the lubricant can be prevented from dispersing toward the sleeve outer peripheral surface.

A hydrodynamic bearing device according to the ninth invention is the hydrodynamic bearing device according to the eighth invention, in which the lube repellent application area which is formed on the one of the shaft and the sleeve and the lube repellent application area adjacent to the lube repellent non-application area located on the surface opposing the lube repellent application area have an overlapping portion which overlaps each other in a direction along the opposing surface.

Here, the lube repellent application areas and the lube repellent non-application area are located on the opposing surfaces as described above. For example, the lube repellent application area formed on the sleeve is formed so as to overlap an lube repellent application area adjacent to the lube repellent non-application area formed on the hub at a position opposing the former lube repellent application area in a direction along the opposing surface.

With such a structure, the lubricant can be securely held at the lube repellent non-application area formed on one of the hub (shaft) and the sleeve, and can be prevented from dispersing.

A hydrodynamic bearing device according to the tenth invention is the hydrodynamic bearing device according to the seventh invention, in which the lube repellent application areas are formed on a surface opposing the lube repellent application areas which are formed on one of the shaft and the sleeve, and the lube repellent non-application area is formed on a surface opposing the lube repellent non-application area.

Here, the lube repellent application areas and the lube repellent non-application area are located on the opposing surfaces as described above. For example, when the hub attached to the shaft is located so as to oppose the sleeve in the axial direction of the shaft, the lube repellent application area is formed on the hub at a position opposing the position where the lube repellent application area is formed on the sleeve. Further, the lube repellent non-application area is formed on the hub at a position opposing the position where the lube repellent non-application area is formed on the sleeve.

By forming at least two lube repellent application areas on each of the hub (shaft) and the sleeve, the lube repellent non-application area can be formed on each of the hub (shaft) and the sleeve.

With such a structure, the lubricant tends to move toward the outer periphery can be stemmed by the opposing lube repellent application areas formed on the hub (shaft) and the sleeve, and the lubricant can be prevented from dispersing.

A hydrodynamic bearing device according to the eleventh invention is the hydrodynamic bearing device according to the tenth invention, in which a clearance between two of the opposing lube repellent application areas which are located at a position closer to the outside than the lube repellent non-application areas from the opening portion is formed so as to be narrower than a clearance between the opposing lube repellent non-application areas. Here, the lube repellent application areas and the lube repellent non-application areas are located on the opposing surfaces as described above. And, a clearance between two of the opposing lube repellent application areas which are located at a position closer to the outside than the lube repellent non-application areas from the bearing portion is formed so as to be narrower than a clearance between the opposing lube repellent non-application areas.

With such a structure, the lubricant can be effectively stemmed by the opposing lube repellent application areas formed on the hub (shaft) and the sleeve.

A spindle motor according to the twelfth invention includes the hydrodynamic bearing device according to the first invention.

Here, a spindle motor includes the hydrodynamic bearing device as described above.

With such a structure, a spindle motor which can enhance operating efficiency of a step of filling a lubricant and also effectively suppress leakage of the lubricant to an outer peripheral portion of the hydrodynamic bearing device can be provided.

An information recording and reproducing apparatus according to the thirteenth invention includes a recording medium, a head, and a spindle motor. The head records and reproduces information on and from the recording medium. The spindle motor is the spindle motor according to the twelfth invention which drives the recording medium or the head to rotation.

Here, an information recording and reproducing apparatus includes the spindle motor as described above.

With such a structure, an information recording and reproducing apparatus which can enhance operating efficiency of a step of filling a lubricant and also effectively suppress leakage of the lubricant to an outer peripheral portion of the hydrodynamic bearing device can be provided.

A hydrodynamic bearing device according to the fourteenth invention includes a sleeve, a shaft, a lubricant, and a first lube repellent application area. The sleeve has an opening portion as a bearing hole on at least one end. The shaft is inserted into the bearing hole of the sleeve and is supported so as to be relatively rotatable with respect to the sleeve. The lubricant is interposed in a clearance between the sleeve and the shaft. The first lube repellent application area includes a circular portion to which an lube repellent is applied in a ring shape with the shaft being a substantial center and a raking portion to which the lube repellent is continuously applied at a position inside the circular portion in a pattern extending toward inside the bearing hole along a direction opposite to the direction of the relative rotation, and is formed at least on a rotating one of opposing surfaces of the shaft and the sleeve which oppose each other.

Here, the first lube repellent application area including a circular portion to which an lube repellent is applied in a ring shape with the shaft being a substantial center and a raking portion to which the lube repellent is continuously applied at a position inside the circular portion in a pattern extending toward inside the bearing hole along a direction opposite to the direction of the relative rotation is formed at least on a rotating one of opposing surfaces of the shaft and the sleeve which oppose each other. Herein, the relative rotational direction refers to the direction of rotation for the rotating member, and refers to the direction opposite to the direction of rotation of the rotating member for the stationary member.

The shaft in such a structure may include a hub which is integral or is attached by fixing (in a shaft-rotary type device), fixed portions such as a base chassis, a motor bracket, a base cover (in a shaft-fixed type device), or the like. The sleeve may include a sleeve cover, a sleeve holder, and further, a base chassis, a motor bracket (in a shaft-rotary type device) or a hub (in a shaft-fixed type device), and so on. The circular pattern in the first lube repellent application area does not have to be a perfect circle, but may be an ellipse, or a polygon shape. The pattern extending toward the axial center of the shaft may be, for example, a spiral pattern, a radial pattern, or the like.

Conventionally, in the hydrodynamic bearing device, an lube repellent is applied entirely across an upper surface of a sleeve in order to prevent a lubricant from leaking out of bearing portions. In this way, the lubricant is prevented from leaking out of the bearing portions. However, in recent years, the HDDs have been miniaturized. Accordingly, for filling the lubricant into miniaturized bearing devices, if the lubricant is dropped and applied to the open upper surface of the sleeve on which the lube repellent is applied entirely as in the conventional art, the lubricant is split and move toward inner and outer peripheries. This may cause problems such that the lubricant is not supplied to the bearing portion into which the lubricant should be supplied, or the lubricant attaches to an outer peripheral portion of the hydrodynamic bearing device (for example, an outer peripheral surface of the sleeve). Also, since the lubricant easily moves on a surface on which the lube repellent is applied, the lubricant tends to move toward the sleeve outer peripheral surface or the like by vibration of a motor, a centrifugal force, air stream inside the motor or the like once the lubricant spreads over the upper surface of the sleeve where the lube repellent is applied entirely.

Thus, the hydrodynamic bearing device according to the present invention includes the first lube repellent application area including a circular portion to which an lube repellent is applied in a ring shape with the shaft being a substantial center and a raking portion to which the lube repellent is continuously applied at a position inside the circular portion in a pattern extending toward inside the bearing hole along a direction opposite to the direction of the relative rotation, and which is formed at least on a rotating one of opposing surfaces of the shaft and the sleeve which oppose each other.

With such a structure, the lubricant dripped onto the sleeve upper surface during the step of supplying the lubricant is repelled at the circular portion of included in the first lube repellent application area. Thus, the lubricant can remain on a portion inside the circular portion. Furthermore, even when the lubricant leaks out to the sleeve upper surface, the raking portion rakes the lubricant toward the rotary axis center, i.e., inside the bearing portions when the shaft (hub) relatively rotates with respect to the sleeve.

Accordingly, operating efficiency of a step of filling a lubricant can be enhanced, and also leakage of the lubricant to an outer peripheral portion of the hydrodynamic bearing device can be effectively suppressed.

A hydrodynamic bearing device according to the fifteenth invention is the hydrodynamic bearing device according to the fourteenth invention, in which the first lube repellent area is formed on the rotating one of the opposing surfaces, and a second lube repellent application area to which the lube repellent is applied entirely across a surface is further provided on the other of the opposing surfaces, which is a fixed one.

Here, the first lube repellent application area including a circular portion to which an lube repellent is applied in a ring shape with the shaft being a substantial center and a raking portion to which the lube repellent is continuously applied at a position inside the circular portion in a pattern extending toward the axial center of the shaft along a direction opposite to the direction of the relative rotation is formed on a rotating one of opposing surfaces of the hub which is fixed to or integrally formed with the shaft and the sleeve which oppose each other in the axial direction of the shaft. The second lube repellent application area to which the lube repellent is applied entirely across a surface is formed on the other of the opposing surfaces, which is a fixed one.

With such a structure, the raking portion can securely rake the lubricant when the shaft (hub) relatively rotates with respect to the sleeve. Accordingly, efficiency in raking the lubricant on the opposing surface can be easily enhanced.

A hydrodynamic bearing device according to the sixteenth invention is the hydrodynamic bearing device according to fourteenth invention, in which the shaft includes a fixed portion which is fixed or integrally formed.

Here, if the hydrodynamic device is of the shaft-rotary type, it includes a hub as a fixed portion which is fixed to or integrally formed with the shaft. If the hydrodynamic bearing device is of the shaft-fixed type, it includes a base chassis or a motor bracket as a fixed portion which is fixed to or integrally formed with the shaft, and also a base cover located above the motor, if both ends of the shaft are fixed.

With such a structure, design flexibility can be enhanced because the lube repellent application areas and the lube repellent non-application area can also be formed on the fixed portions such as hub and the like, for example.

A spindle motor according to the seventeenth invention includes the hydrodynamic bearing device according to the fourteenth invention.

Here, a spindle motor includes the hydrodynamic bearing device as described above.

With such a structure, a spindle motor which can enhance operating efficiency of a step of filling a lubricant and also effectively suppress leakage of the lubricant to an outer peripheral portion of the hydrodynamic bearing device can be provided.

An information recording and reproducing apparatus according to the eighteenth invention includes a recording medium, a head, and a spindle motor. The head records and reproduces information on and from the recording medium. The spindle motor is the spindle motor according to the seventeenth invention which drives the recording medium or the head to rotation.

Here, an information recording and reproducing apparatus includes the spindle motor as, described above.

With such a structure, an information recording and reproducing apparatus which can enhance operating efficiency of a step of filling a lubricant and also effectively suppress leakage of the lubricant to an outer peripheral portion of the hydrodynamic bearing device can be provided.

A hydrodynamic bearing device according to the nineteenth invention includes a sleeve, a shaft, a lubricant, a plurality of first areas, and a second area. The sleeve has an opening portion as a bearing hole on at least one end. The shaft is inserted into the bearing hole of the sleeve and is supported so as to be relatively rotatable with respect to the sleeve. The lubricant is interposed in a clearance between the sleeve and the shaft. The plurality of first areas are formed into a circular pattern with the shaft being a substantial center on at least one of the sleeve and the shaft at positions outside a liquid-gas interface between the lubricant and air in a radial direction or in an axial direction. The second area is formed between two of the first areas which are adjacent to each other, and has a surface roughness larger than that of the first areas.

Here, a plurality of first areas are formed into a circular pattern with the shaft being a substantial center on at least one of the sleeve and the shaft at positions outside a liquid-gas interface between the lubricant and air in a radial direction or in an axial direction. Between one first area having the shaft as the substantial center and another first area having the shaft as the substantial center which is formed at position inside or outside the former first area, a second area having the surface roughness larger than that of the first area is formed.

The shaft in such a structure may include a hub which is integral or is attached by fixing (in a shaft-rotary type device), fixed portions such as a base chassis, a motor bracket, a base cover (in a shaft-fixed type device), or the like. The sleeve may include a sleeve cover, a sleeve holder, and further, a base chassis, a motor bracket (in a shaft-rotary type device) or a hub (in a shaft-fixed type device), and so on. The circular pattern of the first area does not have to be a perfect circle, but may be an ellipse, or a polygon shape. Further, a plurality of second areas may be formed.

In general, the lubricant has a characteristic that wettability increases at the area with large surface roughness such that an apparent contact angle becomes further small.

Conventionally, in the hydrodynamic bearing device, an lube repellent is applied entirely across an upper surface of a sleeve in order to prevent a lubricant from leaking out of bearing portions. In this way, the lubricant is prevented from leaking out of the bearing portions. However, in recent years, the HDDs have been miniaturized. Accordingly, for filling the lubricant into miniaturized bearing devices, if the lubricant is dropped and applied to the open upper surface of the sleeve on which the lube repellent is applied entirely as in the conventional art, the lubricant is split and move toward inner and outer peripheries. This may cause problems such that the lubricant is not supplied to the bearing portion into which the lubricant should be supplied, or the lubricant attaches to an outer peripheral portion of the hydrodynamic bearing device (for example, an outer peripheral surface of the sleeve). Also, since the lubricant easily moves on a surface on which the lube repellent is applied, the lubricant tends to move toward the sleeve outer peripheral surface or the like by vibration of a motor, a centrifugal force, air stream inside the motor or the like once the lubricant spreads over the upper surface of the sleeve where the lube repellent is applied entirely.

Thus, the hydrodynamic bearing device according to the present invention includes a plurality of first areas formed into a circular pattern with the shaft being a substantial center on at least one of the sleeve and the shaft at positions outside a liquid-gas interface between the lubricant and air in a radial direction or in an axial direction, and a second area having a surface roughness larger than that of the first area which is formed between two of the first areas adjacent to each other.

With such a structure, the lubricant dripped onto the sleeve upper surface during the step of supplying the lubricant can remain on second area having a surface roughness larger than that of the first area due to the wettability of the lubricant. Furthermore, the lubricant remaining on the second area and the lubricant inside the bearing portion can be separated perfectly by the innermost first area. Thus, even when the excess lubricant remaining on the sleeve upper surface is wiped off, the lubricant filled inside the bearing portions can be prevented from being wiped off inadvertently. Moreover, even when the lubricant leaks out to the sleeve upper surface, the lubricant can be held on the second area.

Accordingly, operating efficiency of a step of filling a lubricant can be enhanced, and also leakage of the lubricant to an outer peripheral portion of the hydrodynamic bearing device can be effectively suppressed.

A hydrodynamic bearing device according to the twentieth invention is the hydrodynamic bearing device according to the nineteenth invention, in which an lube repellent is applied to the first areas.

Here, the lube repellent is applied to the first areas.

In general, excess dispersion of the lube repellent is prevented during the step of applying the lube repellent when the surface roughness is large. Thus, the lube repellent can be selectively applied to the first area having small surface roughness.

A spindle motor according to the twenty-first invention includes the hydrodynamic bearing device according to the nineteenth invention.

Here, a spindle motor includes the hydrodynamic bearing device as described above.

With such a structure, a spindle motor which can enhance operating efficiency of a step of filling a lubricant and also effectively suppress leakage of the lubricant to an outer peripheral portion of the hydrodynamic bearing device can be provided.

An information recording and reproducing apparatus according to the twenty-second invention includes a recording medium, a head, and a spindle motor. The head records and reproduces information on and from the recording medium. The spindle motor is the spindle motor according to the twenty-first invention which drives the recording medium or the head to rotation.

Here, an information recording and reproducing apparatus includes the spindle motor as described above.

With such a structure, an information recording and reproducing apparatus which can enhance operating efficiency of a step of filling a lubricant and also effectively suppress leakage of the lubricant to an outer peripheral portion of the hydrodynamic bearing device can be provided.

A hydrodynamic bearing device according to the twenty-third invention includes a sleeve, a shaft, a lubricant, a bearing portion, a cover, an inner lube repellent application area, an outer lube repellent application area, and an lube repellent non-application area. The sleeve has a bearing hole into which the shaft is inserted so as to be relatively rotatable, and has one end being closed. The lubricant is interposed in a clearance between the sleeve and the shaft. The bearing portion supports the sleeve and the shaft in a radial direction and an axial direction of the shaft with the lubricant. The cover is located to face an end surface of an open end of the sleeve and has at least one opening formed near the shaft, a lubricant reservoir formed in a space formed together with the sleeve; and at least one vent hole for communicating the lubricant reservoir and the outside of the bearing portion. The inner lube repellent application area is formed into a ring pattern with the shaft being a substantial center on a surface of the cover which is further from the bearing portion at a position closer to the shaft than the vent hole in the radial direction. The outer lube repellent application area is formed into a ring pattern with the shaft being a substantial center on the surface of the cover which is further from the bearing portion at a position further from the shaft than the vent hole in the radial direction. The lube repellent non-application area is formed between the inner lube repellent application area and the outer lube repellent application area.

Here, the inner and outer lube repellent application areas are formed on the cover having the vent hole located at the open end of the sleeve at positions inside and outside the vent hole, respectively. The lube repellent non-application area is formed between the inner lube repellent application area and the outer lube repellent application area.

The circular pattern of the inner and outer lube repellent application areas does not have to be a perfect circle, but may be an ellipse, or a polygon shape. Further, a plurality of inner and outer lube repellent application areas, and the lube repellent non-application areas may be formed. The open end of the sleeve refers to an end opposite to the closed end of the sleeve.

Conventionally, in the hydrodynamic bearing device, an lube repellent is applied entirely across an upper surface of a sleeve in order to prevent a lubricant from leaking out of bearing portions. In this way, the lubricant is prevented from leaking out of the bearing portions. In the hydrodynamic bearing device including the cover which has the vent hole as described above, the lubricant is filled in vacuum such that the entire vent hole is covered in order to reduce the risk that a bubble enters into the bearing portion. However, if the lubricant is dropped and applied to the open upper surface of the sleeve on which the lube repellent is applied entirely as in the conventional art, the lubricant dripped onto the lube repellent application area is split and move toward inner and outer peripheries. This may cause problems such that the lubricant is not supplied to the bearing portion into which the lubricant should be supplied, or the lubricant attaches to an outer peripheral portion of the hydrodynamic bearing device (for example, an outer peripheral surface of the sleeve). Also, since the lubricant easily moves on a surface on which the lube repellent is applied, the lubricant tends to move toward the cover outer peripheral surface or the like by vibration of a motor, a centrifugal force, air stream inside the motor or the like once the lubricant spreads over the upper surface of the sleeve where the lube repellent is applied entirely.

Thus, the hydrodynamic bearing device according to the present invention includes the inner and outer lube repellent application areas formed at positions inside and outside the vent hole, and lube repellent non-application area formed between the inner lube repellent application area and the outer lube repellent application area on the outer end surface of the bearing portion of the sleeve. i.e., an end surface to which the lubricant is supplied.

With such a structure, the lubricant dripped onto the sleeve upper surface during the step of supplying the lubricant is repelled at the inner and outer lube repellent application areas, and can remain on the lube repellent non-application area formed between the inner lube repellent application area and the outer lube repellent application area, and be guided toward the vent hole. Furthermore, the lubricant remaining on the lube repellent non-application area and the lubricant inside the bearing portion can be separated perfectly by the inner lube repellent application area. Thus, even when the excess lubricant remaining on the cover upper surface is wiped off, the lubricant filled inside the bearing portions can be prevented from being wiped off inadvertently. Moreover, even when the lubricant leaks out to the cover upper surface, the lubricant can be held on the lube repellent non-application area formed between the inner lube repellent application area and the outer lube repellent application area.

Accordingly, operating efficiency of a step of filling a lubricant can be enhanced, and also leakage of the lubricant to an outer peripheral portion of the hydrodynamic bearing device can be effectively suppressed.

A spindle motor according to the twenty-fourth invention includes the hydrodynamic bearing device according to the twenty-third invention.

Here, a spindle motor includes the hydrodynamic bearing device as described above.

With such a structure, a spindle motor which can enhance operating efficiency of a step of filling a lubricant and also effectively suppress leakage of the lubricant to an outer peripheral portion of the hydrodynamic bearing device can be provided.

An information recording and reproducing apparatus according to the twenty-fifth invention includes a recording medium, a head, and a spindle motor. The head records and reproduces information on and from the recording medium. The spindle motor is the spindle motor according to the twenty-fourth invention which drives the recording medium or the head to rotation.

Here, an information recording and reproducing apparatus includes the spindle motor as described above.

With such a structure, an information recording and reproducing apparatus which can enhance operating efficiency of a step of filling a lubricant and also effectively suppress leakage of the lubricant to an outer peripheral portion of the hydrodynamic bearing device can be provided.

According to the hydrodynamic bearing device, the spindle motor including the same; and the information recording and reproducing apparatus of the present invention, operating efficiency of a step of filling a lubricant can be enhanced, and also, leakage of the lubricant to an outer peripheral portion of the hydrodynamic bearing device can be effectively suppressed.

### BRIEF DESCRIPTION OF THE DRAWINGS

FIG. 1 is a cross sectional view showing a hydrodynamic bearing device according to the first embodiment of the present invention.

FIGS. 2A and 2B are illustrative diagrams showing a method for supplying a lubricant in a hydrodynamic bearing device according to the present invention.

FIG. 3 is a schematic diagram showing application of the lubricant in a hydrodynamic bearing device according to the present invention.

FIGS. 4A and 4B are perspective views showing the hydrodynamic bearing device according to the first embodiment of the present invention.

FIGS. 5A through 5G are schematic diagrams showing a method for filling the lubricant in the hydrodynamic bearing device according to the first embodiment of the present invention.

FIGS. 6A through 6E are schematic diagrams showing a method for filling the lubricant in the hydrodynamic bearing device according to the second embodiment of the present invention.

FIGS. 7A through 7E are schematic diagrams showing a method for filling the lubricant in the hydrodynamic bearing device according to the third embodiment of the present invention.

FIG. 8 is a cross sectional view showing a spindle motor according to the ninth embodiment of the present invention.

FIGS. 9A and 9B are cross sectional views showing a hydrodynamic bearing device according to the ninth embodiment of the present invention.

FIG. 10 is a cross sectional view showing a hydrodynamic bearing device according to a variation of the first embodiment of the present invention.

FIG. 11 is a cross sectional view showing a conventional hydrodynamic bearing device.

FIGS. 12A through 12E are schematic diagrams showing a method for filling the lubricant in a conventional 3.5-inch type hydrodynamic bearing.

FIGS. 13A through 13F are schematic diagrams showing a method for filling the lubricant in a small-diameter hydrodynamic bearing according to a conventional art.

FIGS. 14A through 14C are schematic diagrams showing a method for filling the lubricant in a small-diameter hydrodynamic bearing according to a conventional art.

FIGS. 15A through 15E are schematic diagrams showing a method for filling the lubricant in a small-diameter hydrodynamic bearing according to a conventional art.

FIGS. 16A through 16F are illustrative diagrams showing a method for filling the lubricant in a hydrodynamic bearing according to the present invention.

FIG. 17 is a cross sectional view showing location of lube repellent application areas according to the fourth embodiment of the present invention.

FIG. 18A is a cross sectional view showing location of lube repellent application areas according to the fifth embodiment of the present invention.

FIG. 18B is a cross sectional view showing location of lube repellent application areas according to a variation of the fifth embodiment of the present invention.

FIG. 19A is a cross sectional view showing location of lube repellent application areas according to the sixth embodiment of the present invention.

FIG. 19B is a cross sectional view showing location of lube repellent application areas according to a variation of the sixth embodiment of the present invention.

FIG. 20A is a plan view showing location of lube repellent application areas formed on a hub according to the seventh embodiment of the present invention.

FIG. 20B is a plan view showing location of lube repellent application areas formed on a sleeve according to the seventh embodiment of the present invention.

FIGS. 21A and 21B are illustrating diagrams showing a mechanism of repelling the oil according to the seventh embodiment of the present invention.

FIG. 22 is a cross sectional view showing location of lube repellent application areas according to the eighth embodiment of the present invention.

FIG. 23 is a cross sectional view showing a hydrodynamic bearing device according to a variation of the first embodiment of the present invention.

FIG. 24 is a cross sectional view showing location of lube repellent application areas according to the tenth embodiment of the present invention.

FIGS. 25A through 25C are schematic diagrams showing a method for filling the lubricant according to the tenth embodiment of the present invention.

FIG. 26A is a plan view showing location of lube repellent application areas formed on a hub according to a variation of the seventh embodiment of the present invention.

FIG. 26B is a plan view showing location of lube repellent application areas formed on a sleeve according to the variation of the seventh embodiment of the present invention.

FIG. 27 is a plan view showing location of lube repellent application areas formed on the hub or the sleeve according to the variation of the seventh embodiment of the present invention.

FIG. 28 is a cross sectional view showing opposing surfaces of the hub and the sleeve according to another variation of the present invention.

FIG. 29 is a cross sectional view showing opposing surfaces of the hub and the sleeve according to another variation of the present invention.

FIGS. 30A through 30C are cross sectional views showing a hydrodynamic bearing device according to a variation of the ninth embodiment of the present invention.

### DETAILED DESCRIPTION OF THE INVENTION

Hereinafter, embodiments of the present invention will be described with reference to the drawings.

### First Embodiment

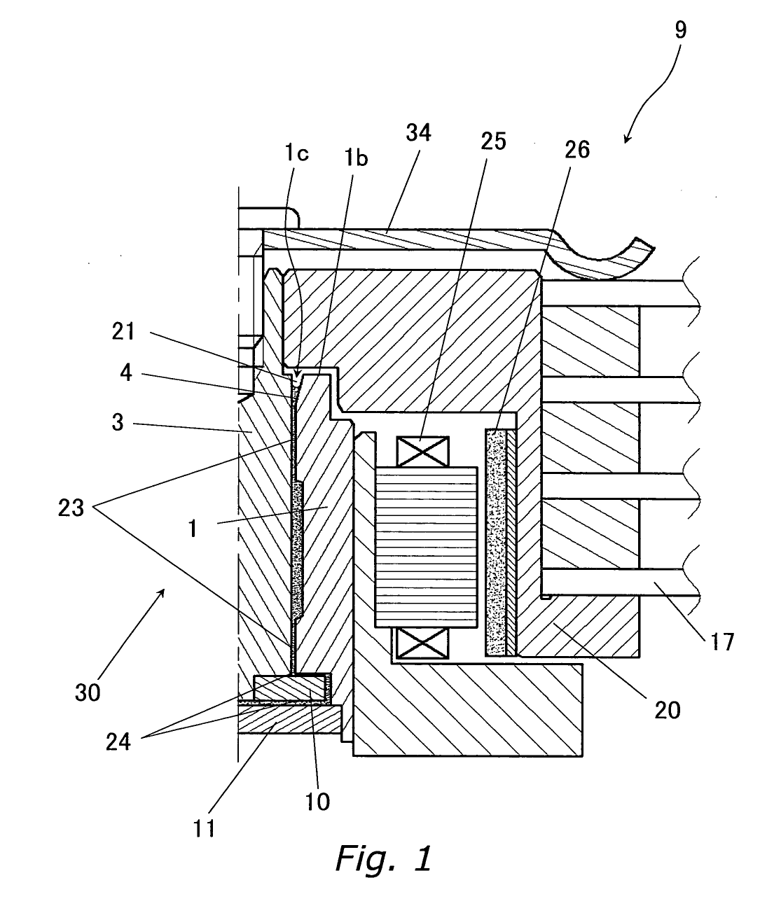

As shown in FIG. 1, a spindle motor 9 according to the present invention can be applied to a hydrodynamic bearing device 30, in which a shaft 3 is inserted into a sleeve 1 having an insertion hole 1c in a central portion with a predetermined clearance interposed therebetween. To the shaft 3, a hub (fixed portion) 20 is attached and magnetic disc 17 is to be attached thereto.

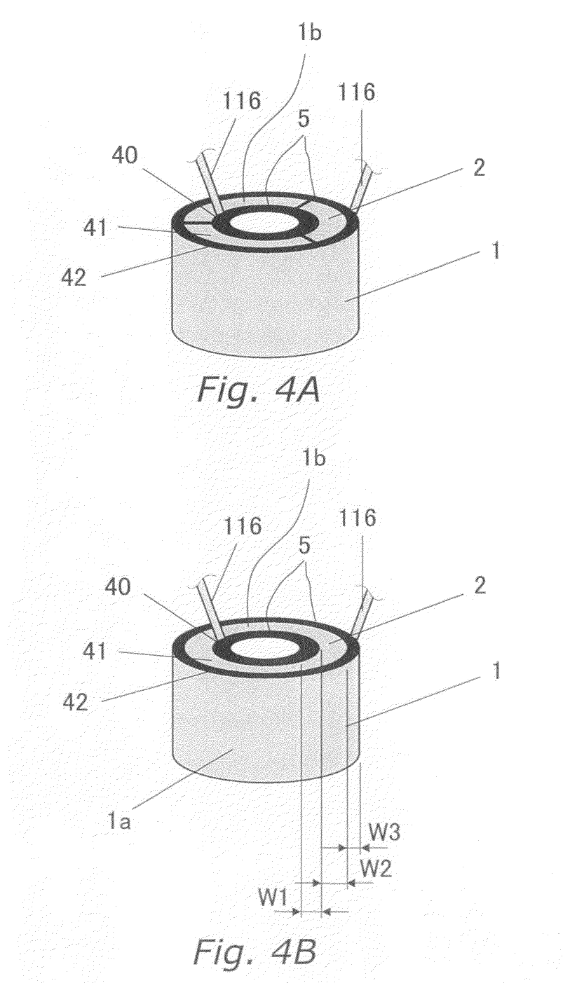

The hydrodynamic bearing device 30 is assembled as follows. As shown in FIG. 4B, first, the sleeve 1 to which the shaft 3 is not yet assembled is prepared. Then, an lube repellent 5 is applied to lube repellent application areas on an open upper surface 1b with a brush, a dispenser nozzle for an lube repellent 116, or the like. There are two lube repellent application areas, i.e., an lube repellent application area 40 on an inner peripheral side and an lube repellent application area 42 on an outer peripheral side. Radial direction widths W1 and W3 of the inner and outer lube repellent application areas 40 and 42 are 0.2 mm or longer (more preferably, 0.6 mm or longer). Between two lube repellent application areas 40 and 42, an lube repellent non-application area 41 to which the lube repellent 5 is not applied is provided. A radial direction width W2 thereof is 0.2 mm or longer (more preferably, 0.6 mm or longer). As the lube repellent 5, an agent having perfluoro tributyl amine as a media and a perfluoro resin mixed therein as a nonvolatile constituent may be used, for example. A material which can be used for thin film coating and in which the nonvolatile constituent will have water repellency and oil repellency after the media is vaporized is preferable. The indicator of preferable water repellency is that the contact angle with water is 90 degrees or higher. As the lubricant 4, ester oil, ether oil, fluorine oil, high flow grease, ionic liquids and the like may be used. It is preferable that the surface tension of the lubricant 4 is 25 to 35 mN/m at a room temperature in view of a sealing function. Under such a condition, the lubricant 4 forms a drop having a diameter of about 0.2 mm when it condenses on the surface coated with the lube repellent 5. Thus, if the lube repellent application areas 40 and 42 having a radial direction width of 0.2 mm or longer are provided, even when the lubricant 4 condenses on the lube repellent application areas 40 and 42, the lubricant 4 does not bridge over the lube repellent application areas 40 and 42 (for example, between the sleeve outer peripheral portion 1a and the lube repellent non-application area 41). Since the radial direction width of the lube repellent non-application area 41 is 0.2 mm or longer (more preferably, 0.6 mm or longer), the lubricant 4 can be stably placed on the open upper surface 1b.

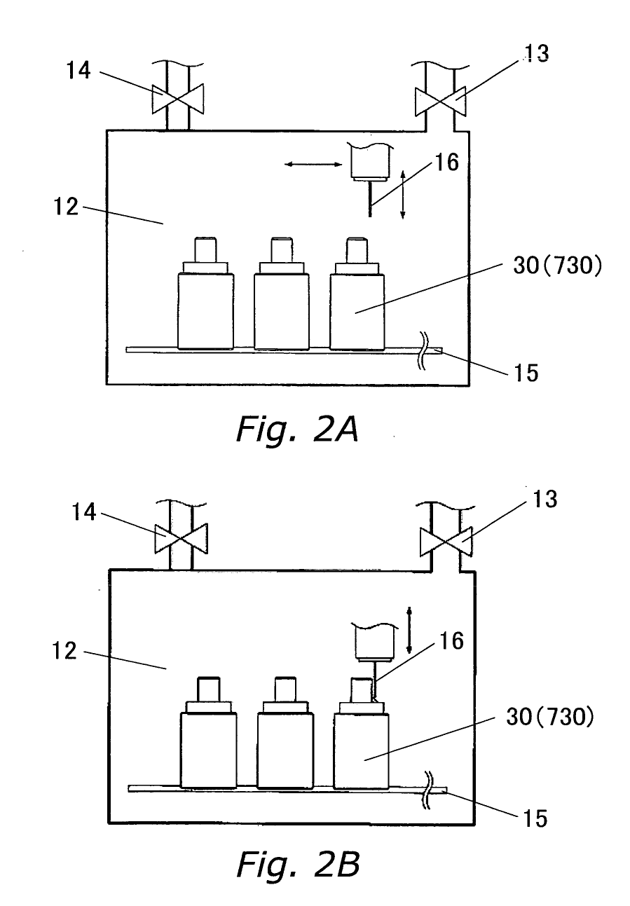

Next, the shaft 3 with the thrust flange 10 being attached thereto and the like are assembled to the sleeve 1, and the thrust plate 11 is fixed to the sleeve 1 by calking, adhering, press-fitting, welding or the like to form the hydrodynamic bearing device 30. Then, as shown in FIG. 2A, the hydrodynamic bearing device 30 is left in a vacuum chamber 12, where the atmosphere is remained near vacuum, for a predetermined time period or longer. The air remained in clearances between the sleeve 1 and the shaft 3, between the thrust flange and the sleeve, between the thrust flange and the thrust plate, and the like is evacuated to obtain a state near vacuum. The vacuum chamber 12 is connected to a vacuum pump (not shown) via a vacuum channel having a vacuum valve 13. Also, an air channel having an air valve 14 is connected to the vacuum chamber 12 for restoring the pressure inside the chamber to the atmospheric pressure. Furthermore, in the vacuum chamber 12, a plurality of the hydrodynamic bearing devices 30 can be placed on a table 15 with the opening and the open upper surface 1b of the sleeve 1 being on the upper side, and a supplying jig such as a dispenser nozzle 16 or the like for supplying the lubricant 4 to the hydrodynamic bearing devices 30 is located so as to be movable.

After the pressure inside the vacuum chamber 12 is reduced to a state of a first pressure which is lower than the atmospheric pressure and a predetermined time period has elapsed, as shown in FIG. 2B, a predetermined amount, which corresponds to the size of the bearing, of the lubricant 4 (including a margin to allow for a dimensional error) (about 0.5 to 15 μL) is supplied to a position which is inner than the outer lube repellent application area 42 and closer to the outer peripheral surface of the shaft 3 by using the supplying jig such as a dispenser nozzle 16 or the like (lubricant supplying step).

At last, the air valve 14 is opened slowly to increase the pressure inside the vacuum chamber 12 to be a second pressure which is higher than the first pressure. Then, the lubricant 4 is attracted toward and flows into the radial bearing portion 23 side from the clearance between the sleeve 1 and the shaft 3 (the bearing seal portion 21) by a capillary pressure and the atmospheric pressure (lubricant filling step).

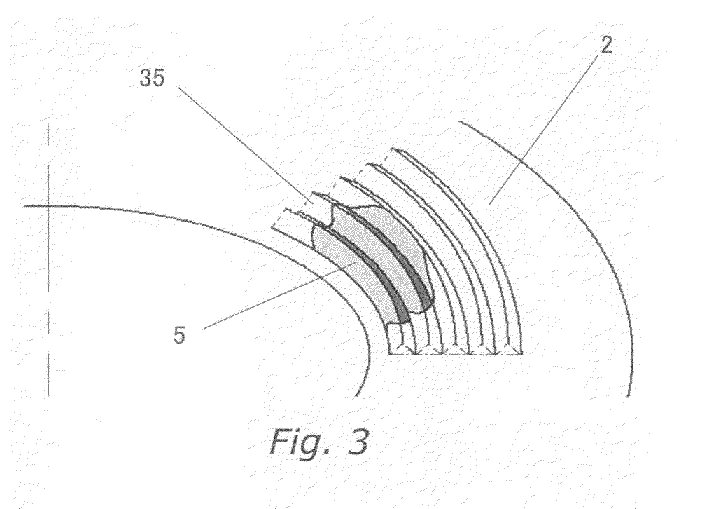

Now, a method for applying the lube repellent 5 to the open upper surface of the sleeve 1 in the present invention will be described. The viscosity of the lube repellent 5 when it is a liquid before drying and curing is almost equal to the viscosity of the lubricant 4. However, the surface tension thereof is about ⅔ or lower than that of the lubricant 4. Thus, when the lube repellent 5 is applied to a metal surface, it easily spreads across an area having a uniform surface state. Therefore, in the case where the surface state such a surface roughness and the like differs among the radial direction and the circumferential direction due to a texture of a sawn surface 35 as in the bearing member processed by lathing or the like shown in FIG. 3, the lube repellent 5 easily spreads in a direction toward smaller surface roughness in general (generally, the circumferential direction when lathing is used for machining).

Thus, it is possible to apply the lube repellent 5 in a narrow shape extending along the circumferential direction by using an extra fine nozzle. On the other hand, the lubricant 4 has a large surface tension and a strong force to reduce a superficial area by forming a ball shape. Thus, it is difficult for the lubricant 4 to spread thin like the lube repellent 5.

Now, as shown in FIGS. 4A and 4B, the lube repellent non-application area 41 is provided on a part of the open upper surface 1b of the sleeve 1 such that inner and outer peripheries of the lube repellent non-application area 41 are enclosed by the lube repellent 5. Specifically, following application methods can be used, but the method is not limited to these methods.

(A) The lube repellent non-application area 41 having a shape of an island is provided. In FIG. 4A, three lube repellent non-application areas 41 are provided. However, there may be one lube repellent non-application area 41 or one or more lube repellent non-application areas 41 may be provided.

(B) The lube repellent non-application area 41 having a circular shape is provided. Inside and outside the lube repellent non-application area 41, the lube repellent application areas 40 and 42 are provided.

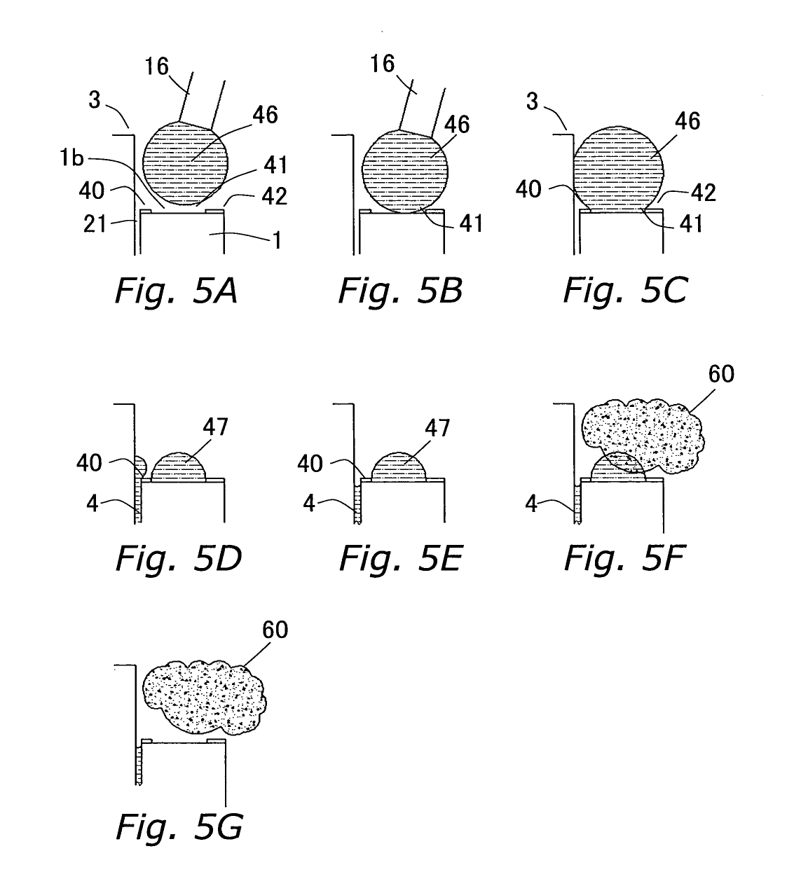

With such a structure, as shown in FIGS. 5A through 5G, the lubricant 4 can be prevented from attaching to the sleeve outer peripheral portion 1a. Since the lube repellent 5 is also applied on the inner peripheral side of the open upper surface 1b, the lubricant 4 is split among the bearing opening and the lube repellent non-application area 41. Thus, the lubricant 4 inside the bearing opening can be prevented from being absorbed when the extra lubricant 4 is wiped off with waste cloth 60 or the like.

Now, specific procedures are described. FIG. 5A shows a state immediately before a lubricant drop 46 is dripped onto the open upper surface 1b of the sleeve 1 in vacuum atmosphere. FIG. 5B shows a state when the lubricant drop 46 is dripped onto the open upper surface 1b of the sleeve 1 in vacuum atmosphere. FIG. 5C shows a state where the lubricant drop 46 stably rests on the open upper surface 1b after the lubricant drop 46 is dripped in vacuum atmosphere and the lubricant drop 46 is separated from the dispenser nozzle 16. Since the lube repellent 5 is applied on the lube repellent application areas 40 and 42, which are provided on the inner and outer peripheral sides of the open upper surface 1b, in a circular pattern, the lubricant drop 46 can be prevented from flowing out to the sleeve outer peripheral portion 1a by the oil repelling effect. FIGS. 5D and 5E show states during a time period while the vacuum atmosphere is gradually restored to normal atmosphere pressure. Differences between pressures inside the radial bearing portion 23 and the thrust bearing portion 24 and the pressure of surrounding area is utilized to supply the lubricant 4 into the radial bearing portion 23 and the thrust bearing portion 24. FIGS. 5F and 5G show a step of wiping off a remaining lubricant drop 47. Since the lube repellent 5 is applied to the lube repellent application area 40 provided on the inner peripheral side of the open upper surface 1b, the lubricant 4 inside the bearing portions 23 and 24 can be prevented from being wiped off too much during the step of wiping off using the waste cloth 60 or the like, for example.

The shape of the above bearing seal portion 21 does not always have be to a tapered shape which has a radial clearance becoming larger toward outside the radial bearing portion 23 and the thrust bearing portion 24. For example, the radial clearance can be made small in the middle of the bearing seal portion 21 so as to prevent the lubricant 4 from leaking out of the bearing seal portion 21 even a shock impact or the like is applied to the hydrodynamic bearing device 30.

Furthermore, the structure of the hydrodynamic bearing device 30 is not limited to the structure as described above. Other types of structures may be applied. For example, instead of the thrust flange 10, the tip portion of the shaft 3 and the thrust plate 11 may be used for forming the thrust bearing portion 24.

To the spindle motor 9 incorporating the hydrodynamic bearing device 30 obtained as described above, magnetic discs 17, which is a recording medium, are fixed to the hub 20 thereof. The spindle motor 9 is then incorporated into an information recording and reproducing apparatus having a head (not shown) which records and reproduces a signal to and from the magnetic discs 17. In this way, it becomes possible to obtain an information recording and reproducing apparatus in which a sufficient amount of the lubricant is filled and generation of gas from the lubricant is suppressed.

In the hydrodynamic bearing device 30 according to the present embodiment, the lube repellent 5 is applied to the outer peripheral portion of the open upper surface 1b. Thus, when the lubricant 4 is supplied, the lubricant 4 is repelled and does not spill out of the sleeve outer peripheral portion 1a. The sleeve outer peripheral portion 1a is fixed to a base plate or the like, which is a part of an HDD, by adhering or the like, in general. In the hydrodynamic bearing device 30 having a structure as described above, the lubricant 4 can be prevented from attaching to the sleeve outer peripheral portion 1a. Thus, adhering strength can be prevented from deteriorating.

Furthermore, since the lube repellent 5 is also applied to the inner peripheral portion of the open upper surface 1b, the lubricant 4 is repelled in this area as well. Thus, the lubricant 4 inside the bearing portions 23 and 24 can be prevented from being absorbed by the waste cloth 60 or the like when the excess lubricant 4 is wiped off from the open upper surface 1b. Also, the lubricant 4 is suppressed from oozing out from the open upper surface 1b of the sleeve 1 and increasing the surface area of evaporation. Thus, evaporation can be effectively prevented. Accordingly, the life of the hydrodynamic bearing device 30 can be prevented from reducing, and increase in the amount of gas generation component can be can be prevented. Also, influences on the functions of HDDs into which the hydrodynamic bearing device 30 is incorporated, particularly, negative impacts on heads and disc surfaces can be reduced, and causes of defectives such as errors in writing and the like can be removed.

### Second Embodiment

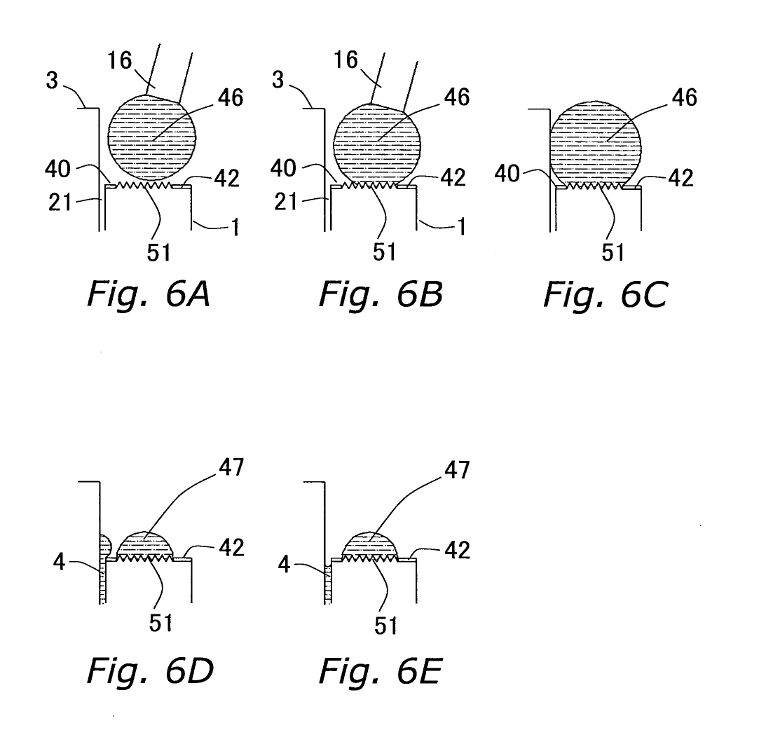

In order to further improve effects of the above first embodiment, as shown in FIGS. 6A through 6E, surface roughness of a radial direction central portion 51 to which the lube repellent 5 is not applied (corresponding to the lube repellent non-application area 41) may be made larger than surface roughness of portions to which the lube repellent 5 is applied (corresponding to the lube repellent application areas 40 and 42).

Specifically, the lube repellent 5 is applied only to the lube repellent application areas 40 and 42 which have smaller surface roughness on the open upper surface 1b. For example, the surface roughness of the lube repellent application areas 40 and 42 on the inner and outer peripheral portions is set to Rz<3, and that of the radial direction central portion 51 is set to twice as large as or larger than Rz. Herein, Rz refers to the maximum height roughness and conforms to the system of notation referred to as JIS B0601:2001(IS04287:1997). Diffusion of the lube repellent 5 is prevented at the portions with the large surface roughness. Thus, it becomes easy to selectively apply the lube repellent 5 only to the lube repellent application areas 40 and 42 which have small surface roughness. The radial direction widths of the lube repellent application areas 40 and 42 and the lube repellent non-application area 41 in the present embodiment may be 0.2 mm or longer (more preferably, 0.6 mm or longer) as in the first embodiment.

Wettability of the lubricant drop 46 increases at the area with large surface roughness (the radial direction central portion 51) such that an apparent contact angle becomes further small. Accordingly, the lubricant drop 46 is securely held on the radial direction central portion 51 of the open upper surface 1b of the sleeve 1.

### Third Embodiment

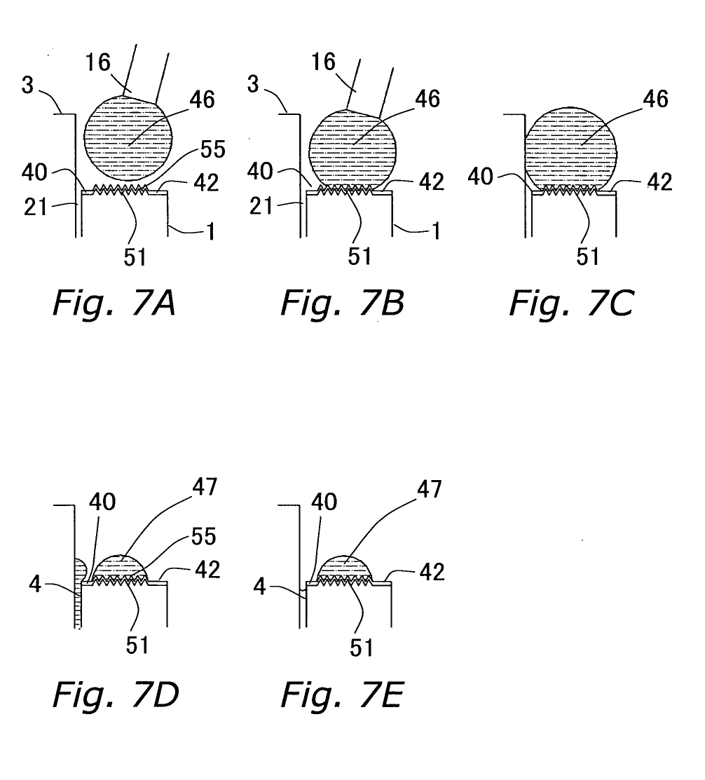

As shown in FIGS. 7A through 7E, when surface roughness of a portion near the inner periphery of the open upper surface 1b of the sleeve 1 (a first area) and a portion near the outer periphery (a first area) is made small, surface roughness of the radial direction central portion 51 (a second area) of the open upper surface 1b is made large, and an lube repellent 55 is applied entirely across the open upper surface 1b, similar effects as those of the second embodiment can be achieved.

According to such a structure, only the surface roughness of the open upper surface 1b of the sleeve 1 has to be changed. Thus, it becomes easy to apply the lube repellent 55. Further, since the wettability of the lubricant drop 46 is good on the radial direction central portion 51, the lubricant drop 46 does not spill out of the outer periphery of the sleeve 1. The area having small surface roughness 40 (the first area) on the inner peripheral side blocks the lubricant 4 from the inside of the radial bearing portion 23 and the thrust bearing portion 24. Thus, conventional problems which occur during the step of wiping off using a waste cloth or the like can be solved.

In the above first through third embodiments, the lube repellent application areas 40 and 42 are on the open upper surface 1b of the sleeve 1 for the sake of simplicity of explanation. However, the present invention is not limited to such examples. For example, a chamfered portion or a tapered portion may be provided on the inner and outer peripheries of the open upper surface 1b of the sleeve 1, and the lube repellent 55 may be applied thereto.

In the hydrodynamic bearing device 30 according to the present embodiment, the area having small surface roughness (the first area) 42 is provided on the outer peripheral portion of the open upper surface 1b. Thus, when the lubricant 4 is supplied, the lubricant 4 is repelled and does not spill out of the sleeve outer peripheral portion 1a. The sleeve outer peripheral portion 1a is fixed to a base plate or the like, which is a part of an HDD, by adhering or the like, in general. In the hydrodynamic bearing device 30 having the above-described structure, the lubricant 4 can be prevented from being attached to the sleeve outer peripheral portion 1a and thus the adhesive strength can be prevented from deteriorating.

Furthermore, since the area having the small surface roughness 40 is also provided on the inner peripheral side of the open upper surface 1b, the lubricant 4 is repelled in this area as well. Thus, the lubricant 4 inside the bearing portions 23 and 24 can be prevented from being absorbed by the waste cloth 60 or the like when the excess lubricant 4 is wiped off from the open upper surface 1b. Also, evaporation of the lubricant 4 can be effectively suppressed. Thus, the life of the hydrodynamic bearing device 30 can be prevented from reducing, and increase in the gas generation component can be suppressed. Accordingly, influences on the functions of HDDs into which the hydrodynamic bearing device 30 is incorporated, particularly, negative impacts on heads and disc surfaces can be reduced, and causes of defectives such as errors in writing and the like can be removed.

### Fourth Embodiment

In the spindle motor 9 according to the first embodiment, two lube repellent application areas 40 and 42 are formed on the open upper surface 1b. However, the present invention is not limited to such an example.

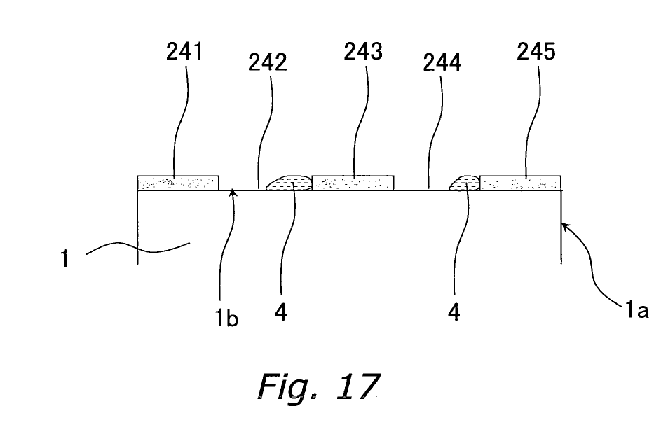

For example, as shown in FIG. 17, two or more lube repellent application areas 241, 243 and 245 on the open upper surface 1b. In such an example, lube repellent non-application areas 242 and 244 are formed between the lube repellent application area 241 and the lube repellent application area 243, and between the lube repellent application area 243 and the lube repellent application area 245.

In general, it is difficult for the lubricant 4 to spread over the lube repellent application areas 241, 243 and 245. Thus, it becomes possible to prevent the lubricant 4 from dispersing toward the sleeve outer peripheral portion 1a by providing a plurality of the lube repellent application areas.

### Fifth Embodiment

In the spindle motor 9 according to the first embodiment, the lube repellent application areas 40 and 42 are formed on the open upper surface 1b. However, the present invention is not limited to such an example.

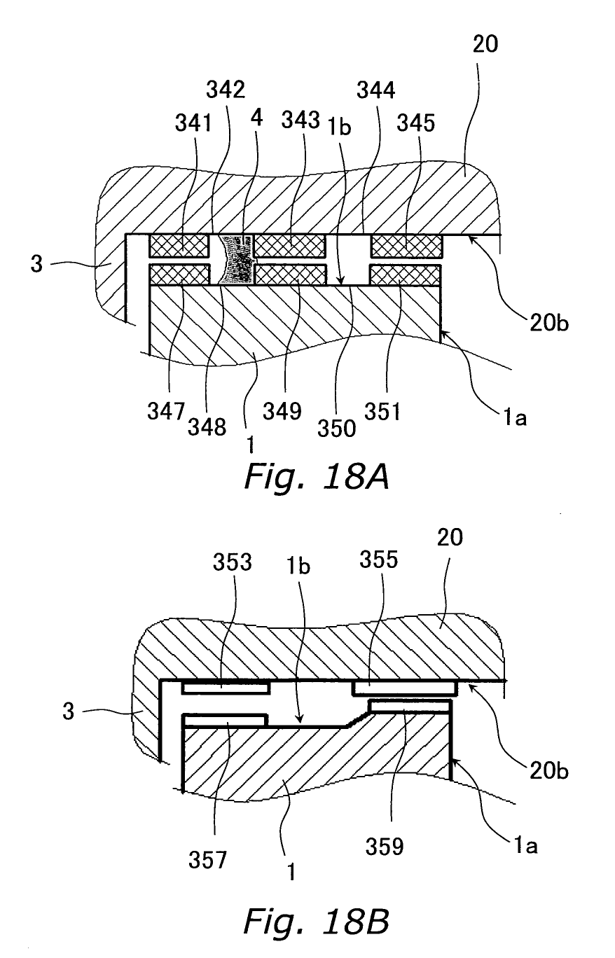

For example, as shown in FIG. 18A, lube repellent application areas 341, 343, 345, 347, 349 and 351 may be formed on opposing surfaces 1b and 20b of the sleeve 1 and the hub 20 which opposes thereto in the axial direction of the shaft 3. The lube repellent application areas (specifically, the lube repellent application area 341 and the lube repellent application area 347, the lube repellent application area 343 and the lube repellent application area 349, and the lube repellent application area 345 and the lube repellent application area 351) and the lube repellent non-application areas (the lube repellent non-application area 342 and the lube repellent non-application area 348, and the lube repellent non-application area 344 and the lube repellent non-application area 350) may be located so as to oppose each other.

With such a structure, the lubricant 4 can be stemmed by opposing lube repellent application areas formed on the hub 20 and the sleeve 1. Thus, the lubricant 4 can be prevented from dispersing toward the sleeve outer peripheral portion 1a.

Alternatively, as shown in FIG. 18B, lube repellent application areas 353, 355, 357, and 359 may be formed on opposing surfaces. A clearance between the opposing surfaces in the axial direction of the shaft 3 is formed so as to be smaller on the outer side in the radial direction of the shaft 3 than on the inner side. Specifically, the clearance between the opposing surfaces 1b and the 20b is smaller at the position where the lube repellent application area 355 and the lube repellent application area 359 are formed than at the position where the lube repellent application area 353 and the lube repellent application area 357 are formed. With such a structure, the lubricant 4 can be effectively stemmed by the opposing lube repellent application areas 353, 355, 357, and 359 formed on the hub 20 and the sleeve 1.

### Sixth Embodiment

In the spindle motor 9 according to the first embodiment, the lube repellent application areas 40 and 42 are formed on the open upper surface 1b. However, the present invention is not limited to such an example.

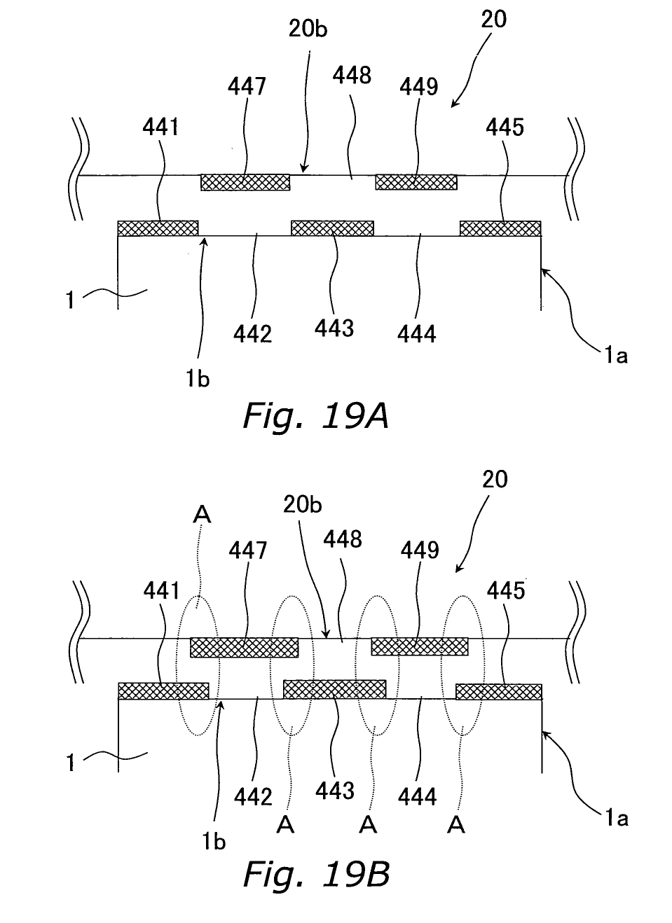

For example, as shown in FIG. 19A, lube repellent application areas 441, 443, 445, 447, and 449 may be formed on opposing surfaces 1b and 20b of the sleeve 1 and the hub 20 which opposes thereto in the axial direction of the shaft 3. The lube repellent application areas and the lube repellent non-application areas (specifically, the lube repellent application area 443 and the lube repellent non-application area 448, the lube repellent application area 447 and the lube repellent non-application area 442, and the lube repellent application area 449 and the lube repellent non-application area 444) may be located so as to oppose each other.

With such a structure, the lubricant 4 can be held on the lube repellent non-application areas 442 and 444 formed on the open upper surface 1b, which is a non-rotating member. Furthermore, even when the lubricant 4 held by the lube repellent non-application areas 442 and 444 contacts the opposing surface 20b of the hub 20, which is the rotating member, influence of the centrifugal force applied by rotation can be suppressed because the contacting portions of the surface are the lube repellent application areas 447 and 449 and have poor wettability. As to the lubricant 4 attached to the opposing surface 20b of the hub 20, which is the rotating member, anchorage is applied stronger than the centrifugal force as long as the drop of the lubricant 4 is small, and thus, the lubricant 4 does not disperse. If the drop of the lubricant 4 is large, the lubricant 4 tends to move toward the outer periphery of the hub 20 due to the centrifugal force. However, the lubricant 4 can be held by the lube repellent non-application areas 442 and 444 formed on the sleeve upper surface 1b. Thus, the lubricant 4 can be prevented from dispersing toward the sleeve outer peripheral portion 1a.

Alternatively, as shown in FIG. 19B, the lube repellent application areas 443, 447 and 449 formed on one of the hub 20 and the sleeve 1 and lube repellent application areas 441, 443, 445, 447, and 449, which are adjacent to the lube repellent non-application areas 442, 444, and 448 located on the surface opposing the lube repellent application areas 443, 447 and 449, may have overlapping portions A where they overlap each other in the radial direction of the shaft 3.

With such a structure, the lubricant 4 can be held securely on the lube repellent non-application areas 442, 444, and 448 formed on the hub 20 and the sleeve 1, and the lubricant 4 can be effectively prevented from dispersing toward the sleeve outer peripheral portion 1a.

### Seventh Embodiment

In the spindle motor 9 according to the first embodiment, the lube repellent application areas 40 and 42 are formed on the open upper surface 1b. However, the present invention is not limited to such an example.

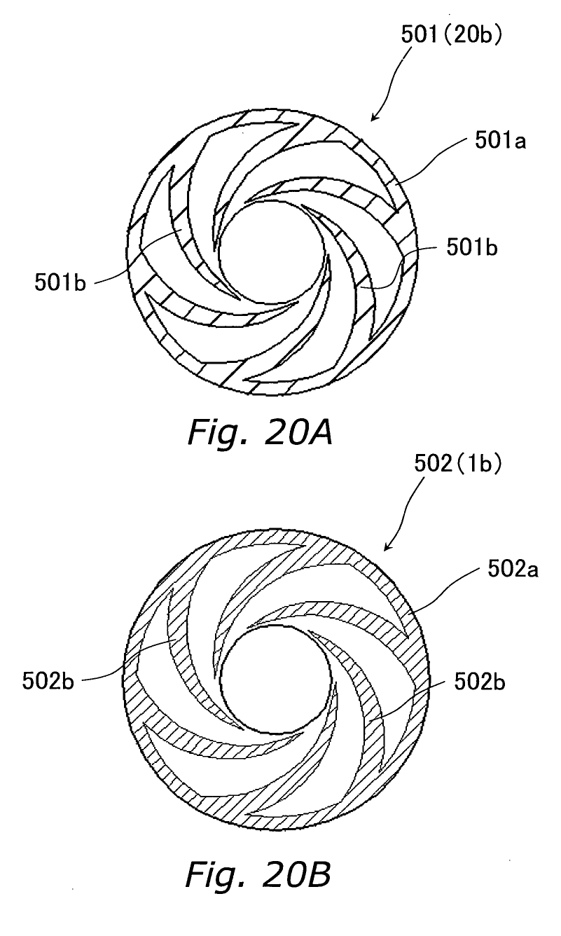

For example, as shown in FIG. 20A, among the opposing surfaces 1b and 20b of the sleeve 1 and the hub 20 which oppose each other in the axial direction of the shaft 3, on the opposing surface 20b of the hub 20, which is the rotating member, a first lube repellent application area 501 may be formed. The first lube repellent application area 501 is formed of a circular portion 501a to which the lube repellent 5 is applied in a circular pattern with the shaft 1 being an approximate center, and a raking portion 501b to which the lube repellent 5 is applied in a pattern extending toward the axial center of the shaft 1 along a direction opposite to the rotational direction (relative rotational direction) of the hub 20.

Further, as shown in FIG. 20B, among the opposing surfaces 1b and 20b of the sleeve 1 and the hub 20 which oppose each other in the axial direction of the shaft 3, on the opposing surface 1b of the sleeve 1, a first lube repellent application area 502 may be formed. The first lube repellent application area 502 is formed of a circular portion 502a to which the lube repellent 5 is applied in a circular pattern with the shaft 1 being an approximate center, and a raking portion 502b to which the lube repellent 5 is applied in a pattern extending toward the axial center of the shaft 1 along a opposite direction of a direction opposite to the rotational direction (relative rotational direction) of the hub 20.

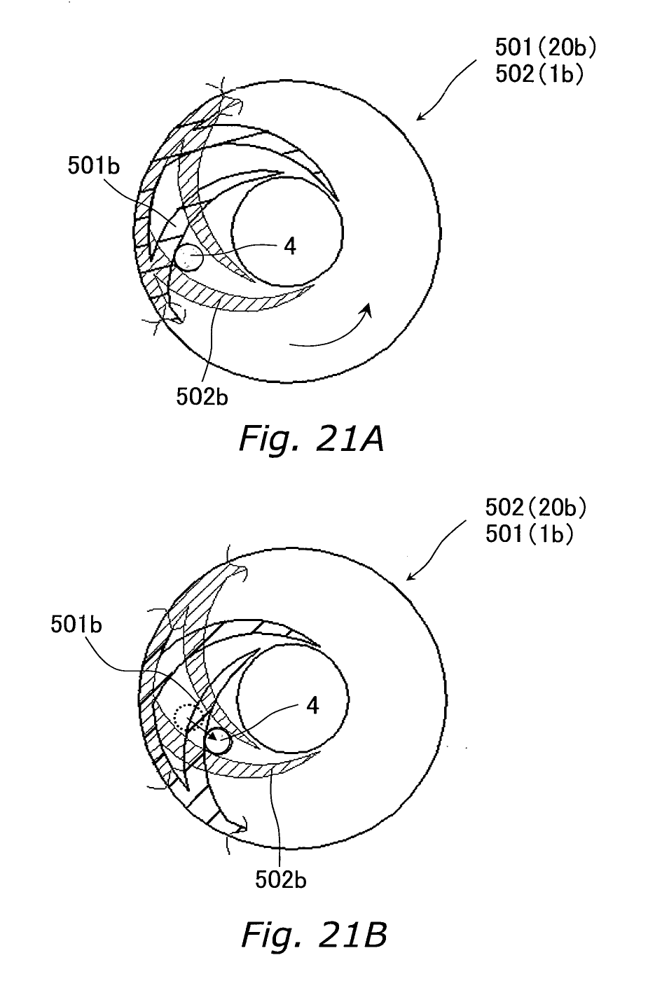

FIGS. 20A and 20B are both plan views viewed from the surfaces to which the lube repellent 5 is applied. For example, if both the first lube repellent application areas 501 and 502 are formed on the opposing surfaces 20b and 1b of the hub 20 and the sleeve 1 which oppose each other, respectively, the lubricant 4 is moved toward the rotational axis center by the first lube repellent application area 501. Specifically, when the lubricant 4 locates at a position as indicated in FIG. 21A, and the hub 20 rotates in the direction indicated by the arrow (relative rotational direction), the lubricant 4 is moved in the rotational center direction as shown in FIG. 21B. This is due to the oil repelling effect of the raking portion 501b extending toward the rotational axis center direction along the direction opposite to the rotational direction (relative rotational direction), which is formed on the hub 20. The lubricant 4 is guided in the rotational axis center direction by the rotation of the hub 20.

The lubricant 4 is moved toward the rotational axis center direction also by the first lube repellent application area 502. Specifically, when the lubricant 4 locates at a position as indicated in FIG. 21A, and the hub 20 rotates in the direction indicated by the arrow (relative rotational direction), the lubricant 4 is moved in the rotational center direction as shown in FIG. 21B. This is due to the oil repelling effect of the raking portion 502b extending toward the rotational axis center direction along the direction opposite to the relative rotational direction (the direction opposite to the rotational direction of the hub 20), which is formed on the open upper surface 1b. The lubricant 4 is guided in the rotational axis center direction by the rotation of the hub 20.

It is not always necessary that both the first lube repellent application areas 501 and 502 are provided on the opposing surfaces 1b and 20b of the sleeve 1 and the hub 20. As long as one of them is provided on the hub 20, which is the rotating member, desirable effects can be achieved.

### Eighth Embodiment

In the spindle motor 9 according to the first embodiment, the lube repellent application areas 40 and 42 formed on the open upper surface 1b are formed on a flat surface. However, the present invention is not limited to such an example.

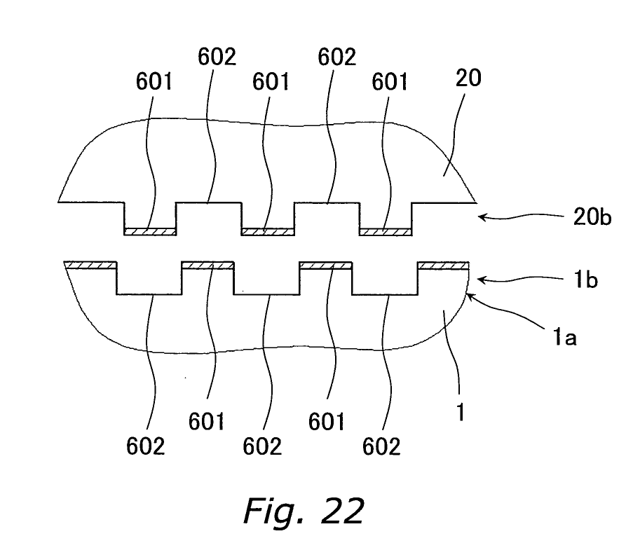

For example, as shown in FIG. 22, concave and convex portions may be provided on the open upper surface 1b of the sleeve 1 and/or on the opposing surface 20b of the hub 20 which opposed to the open upper surface 1b. On the concave and convex portions, lube repellent application areas 601 and/or lube repellent non-application areas 602 may be provided. FIG. 22 shows an example in which the lube repellent application areas 601 are provided on the convex portions of the open upper surface 1b and the opposing surface 20b, and the lube repellent non-application areas 602 are formed on the concave portions of the open upper surface 1b and the opposing surface 20b. Such a structure can also effectively prevent the lubricant 4 from dispersing toward the sleeve outer peripheral portion 1a.

### Ninth Embodiment

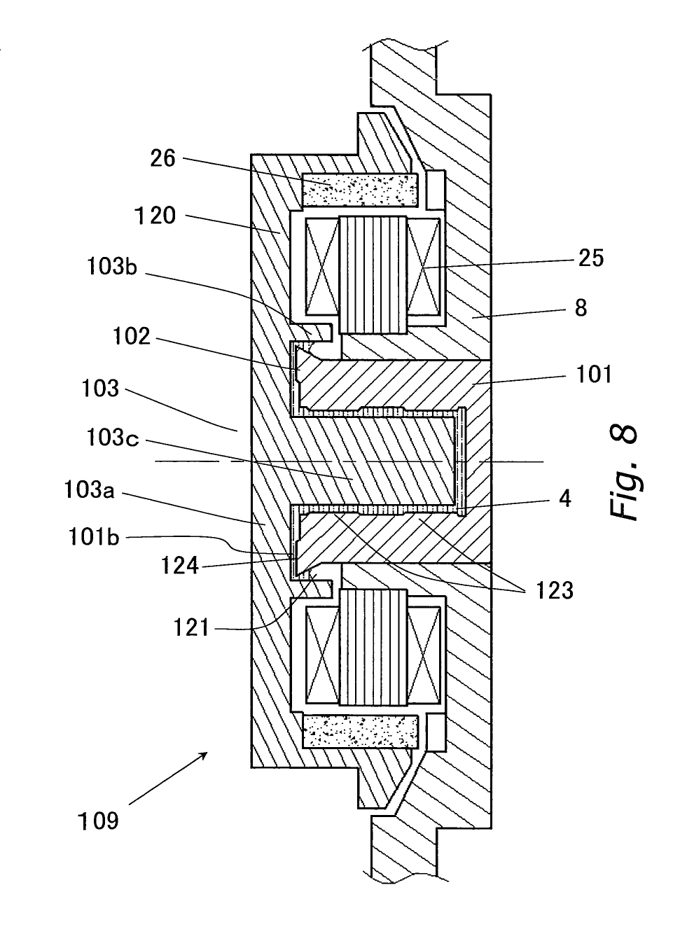

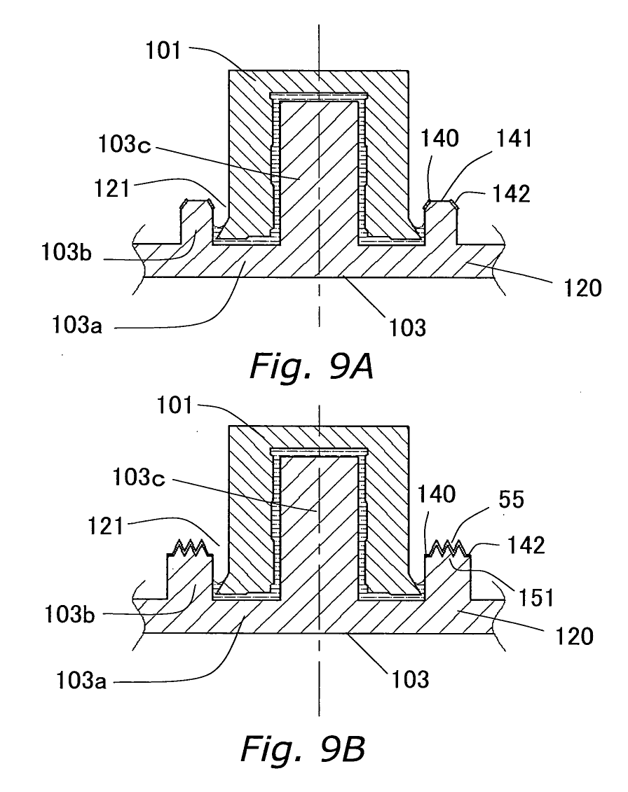

FIG. 8 shows a cross sectional view of a spindle motor 109 according to the ninth embodiment of the present invention. In the present embodiment, a hub 120 for mounting discs (not shown) is formed on an outer peripheral portion of a shaft 103. A cylindrical surface 103c at the center of the shaft 103 is fitted to an inner peripheral surface of a sleeve 101 and forms a radial bearing portion 123. The shaft 103 has a shaft radial direction extending portion 103a and a shaft vertical tubular portion 103b which is located outside the shaft radial direction extending portion 103a. The shaft 103 forms a thrust bearing portion 124 and a bearing seal portion 121 with an open upper surface 101b of the sleeve 101. In this example, as shown in FIG. 9A, lube repellent application areas 140 and 142 and an lube repellent non-application area 141 are provided on an end surface of the shaft vertical tubular portion 103b near the bearing seal portion 121.

For supplying the lubricant 4 to the spindle motor having such a structure, first, as shown in FIG. 9A, the shaft 103 and the sleeve 101 are inverted. Then, air inside the bearing is exhausted by leaving the shaft 103 and the sleeve 101 in a vacuum chamber, where the atmosphere is remained near vacuum. The lubricant 4 is supplied aiming at the lube repellent non-application area 141 near the bearing seal portion 121 by using a dispenser nozzle (not shown). Thereafter, the pressure inside the vacuum chamber is gradually increased to the atmospheric pressure to fill the lubricant 4 inside the bearing clearance. By providing the lube repellent non application area 141 and the lube repellent application areas 140 and 142 near the portion to which the lubricant is supplied, the lubricant 4 can be prevented from spilling out of the portion where it is supplied, as in the above-described first through eighth embodiments.

Surface roughness of the lube repellent non application area 141 may be made larger than that of the lube repellent application areas 140 and 142 so that the lube repellent 55 is hardly applied to the lube repellent non application area 141. Alternatively, as shown in FIG. 9B, the surface roughness of a radial direction central portion 151 of the end surface of the shaft vertical tubular portion 103b may be made large and the lube repellent 55 may be applied entirely across the end surface of the shaft vertical tubular portion 103b.

In the above description, the shaft radial direction elongated portion 103a, the shaft vertical tubular portion 103b, the cylindrical surface 103c, and the hub 120 are integrally formed in the shaft 103. However, the present invention is not limited to such an example. The shaft radial direction elongated portion 103a and the cylindrical surface 103c may be separated components which are integrated by adhering, welding or the like.

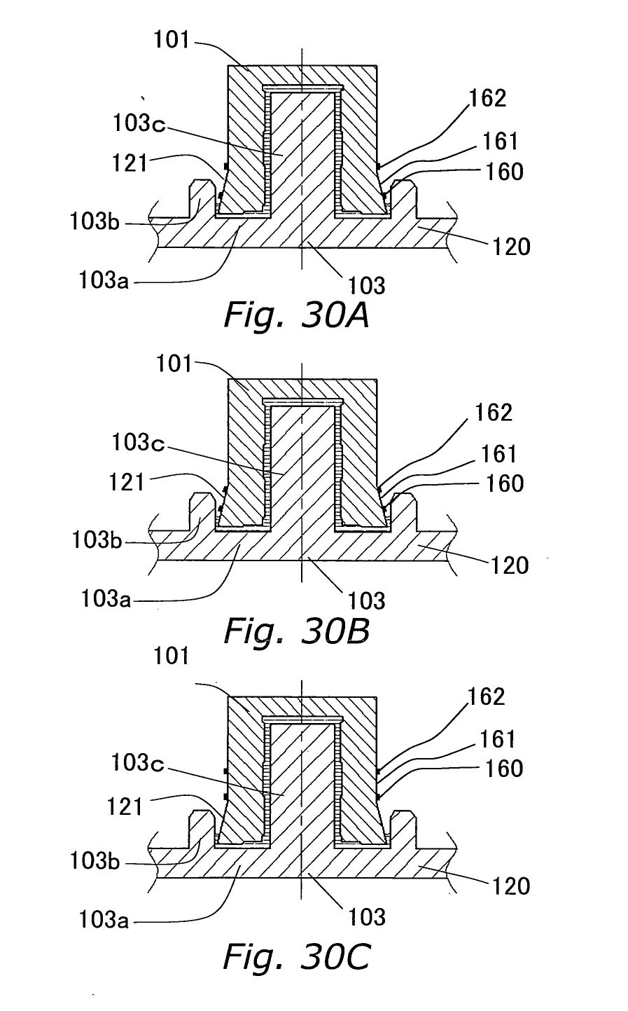

Furthermore, in the above description, the lube repellent is applied on the hub 120. However, as shown in FIGS. 30A, 30B, and 30C as variations, lube repellent application areas 160 and 162 and an lube repellent non-application area 161 may be provided at multiple sites on the outer periphery of the sleeve 101 in the axial direction near the bearing seal portion 121. With such a structure, similar effects as described above can also be achieved.

### Tenth Embodiment

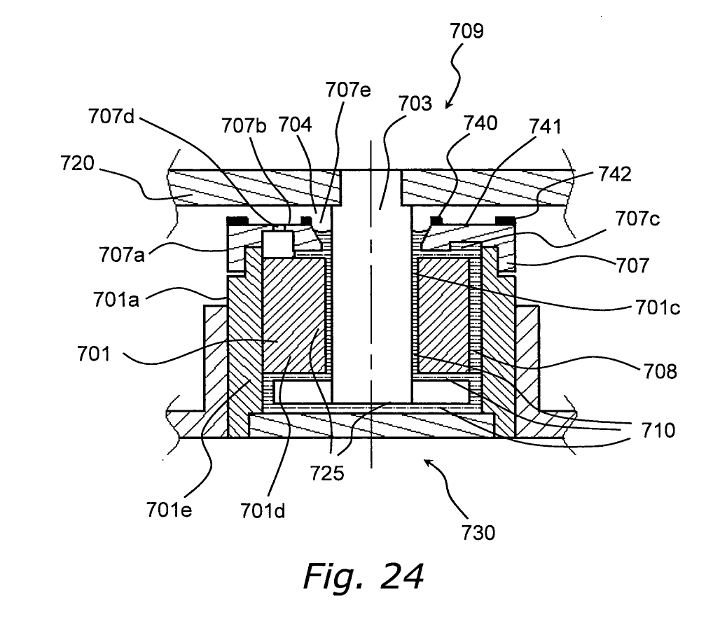

As shown in FIG. 24, a structure of the spindle motor 709 according to the present invention can be applied to a hydrodynamic bearing device 730 including a sleeve 701, a shaft 703, a communication hole 708, and a cover 707.

The sleeve 701 has an insertion hole 701c at a central portion, into which the shaft 703 is inserted with a predetermined clearance interposed therebetween. The sleeve 701 is formed of two members, an inner sleeve 701d formed of a sintered material or the like, and a sleeve holder 701e formed of a metal material such as stainless steel, aluminum, or the like. The two members are fixed to each other by press-fitting adhesion. On an outer periphery of the inner sleeve 701d, a groove having a semicircular cross-section or a D-cut cross-section is formed so as to extend along the axial direction. The groove forms the vent hole 708 when the inner sleeve 701d is fixed to the sleeve holder 701e.

To the shaft 703, a hub 720 for fixing magnetic discs (not shown) is attached. Between the sleeve 701 and the shaft 703, there is provided a bearing portion 710 for supporting the sleeve 701 and the shaft 703 in the axial direction or the radial direction of the shaft 703 with a lubricant 704 being interposed therebetween. The communication hole 708 communicates two end surfaces of the sleeve 701 in the axial direction.

The cover 707 is located so as to oppose the outside of the bearing portion 710 of the sleeve 701 in the axial direction of the shaft 703. The cover 707 has a lubricant reservoir 707c formed together with the sleeve 701, a vent hole 707d which communicates the lubricant reservoir 707c and the outside of the bearing portion 710, and an opening portion 707e. On an upper surface 707b of the cover 707, an inner peripheral lube repellent application area 740 is formed at a position closer to the inner periphery than the vent hole 707d, an outer peripheral lube repellent application area 742 is formed at a position closer to the outer periphery than the vent hole 707d, and an lube repellent non-application area 741 is formed between the inner peripheral lube repellent application area 740 and the outer peripheral lube repellent application area 742.

In the hydrodynamic bearing device 730 having such a structure, the lubricant 704 is filled as follows. Characteristics of the lubricant 704 are similar to those of the lubricant as described in the first embodiment.

First, as shown in FIG. 2A, the hydrodynamic bearing device 730 is left in the vacuum chamber 12, where the atmosphere is remained near vacuum, for a predetermined time period or longer. The air remained in the clearance between the sleeve 701 and the shaft 703 is evacuated to obtain atmosphere near vacuum. The vacuum chamber 12 is connected to the vacuum pump (not shown) via the vacuum channel having the vacuum valve 13. Also, the air channel having an air valve 14 is connected to the vacuum chamber 12 for restoring the pressure inside to the atmospheric pressure. Furthermore, in the vacuum chamber 12, a plurality of the hydrodynamic bearing devices 730 can be placed on the table 15 with the cover 707 being on the upper side, and a supplying jig such as a dispenser nozzle 16 or the like for supplying the lubricant 704 to the hydrodynamic bearing devices 730 is located so as to be movable.

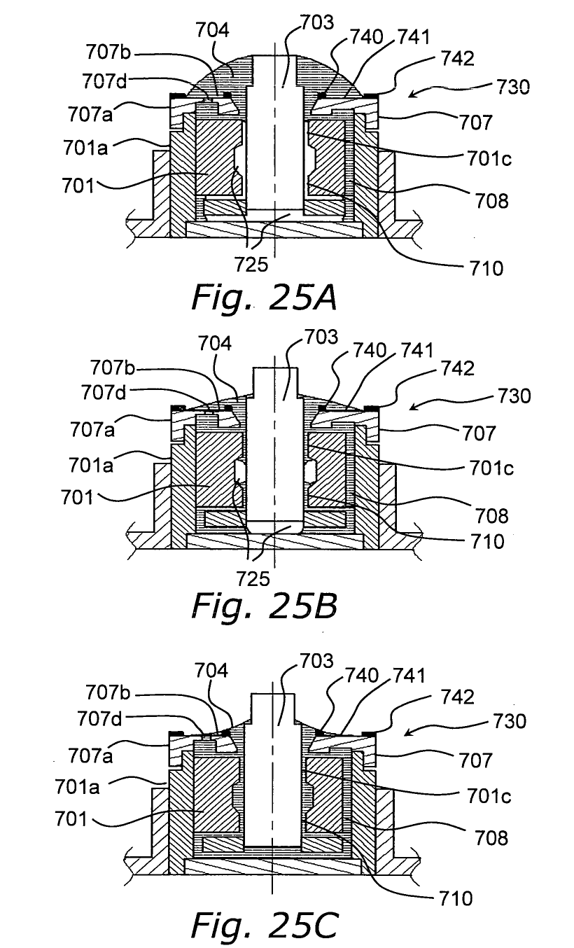

After the pressure inside the vacuum chamber 12 is reduced to a state of a first pressure which is lower than the atmospheric pressure and a predetermined time period has elapsed, as shown in FIGS. 2B and 25B, a predetermined amount, which corresponds to the size of the bearing, of the lubricant 704 (including a margin to allow for a dimension error) (about 0.5 to 15 μL) is supplied so as to cover the vent hole 707d. After a few minutes has elapsed with the state of the first pressure being maintained, as shown in FIG. 25B, the lubricant 704 enters into smaller clearances inside the bearing portion 710 due to a capillary force applied between the lubricant 704 and the sleeve 701 and the shaft 703. Inside the bearing portion 710, at a portion where the clearance becomes larger, the capillary force prevents further permeation of the lubricant 704. Accordingly, the static state is achieved with a plurality of small cavities 725 being left inside the bearing portion 710. The pressure inside the cavities 725 may be regarded as almost equal as the first pressure (lubricant supplying step). This allows reducing the risk that a bubble enter inside the bearing portion 710 when the pressure is restored to the atmospheric pressure in the next step.

At last, the air valve 14 is opened slowly to increase the pressure inside the vacuum chamber 12 to become a second pressure which is higher than the first pressure. In this way, the lubricant 704 flows into the bearing portion 710 by the atmospheric pressure and the lubricant 704 is filled inside the bearing portion 710 as shown in FIG. 25C (lubricant filling step). It is desirable that the vent hole 707d is filled with the lubricant 704 until the filling of the lubricant 704 under the atmospheric pressure is completed.

In the hydrodynamic bearing device 730 according to the present invention, the outer peripheral lube repellent application area 742 is formed on the outer peripheral portion of the cover upper surface 707b. Thus, when the lubricant 704 is filled, the lubricant 704 is repelled by the outer peripheral lube repellent application area 742 and can be prevented from spilling onto the cover outer peripheral portion 707a and the sleeve outer peripheral portion 701a. Furthermore, the inner peripheral lube repellent application area 740 is formed on the inner peripheral surface of the cover upper surface 707b. Thus, the lubricant 704 inside the bearing portion 710 can be prevented from being wiped off too much when the excess lubricant 704 is wiped off from the opening upper portion by the waste cloth 60 or the like. The inner peripheral lube repellent application area 740 also effectively suppresses evaporation of the lubricant 704. This means that it can be prevented from oozing out from the bearing portion 710. Accordingly, the life of the hydrodynamic bearing device 730 can be prevented from reducing, and the increase in the amount of gas generation component can be prevented. Therefore, influences on the functions of HDDs into which the hydrodynamic bearing device 730 is incorporated, particularly, negative impacts on the heads and disc surfaces can be reduced, and causes of defectives such as errors in writing and the like can be removed.

### (Other Variations)

In the embodiments described above, a radial bearing portion is formed on the inner peripheral surface of the sleeve 1, the thrust bearing portion is formed on one of the end surfaces thereof, and the bearing seal portion is formed near the opening thereof. However, the present invention is not limited to such an example.

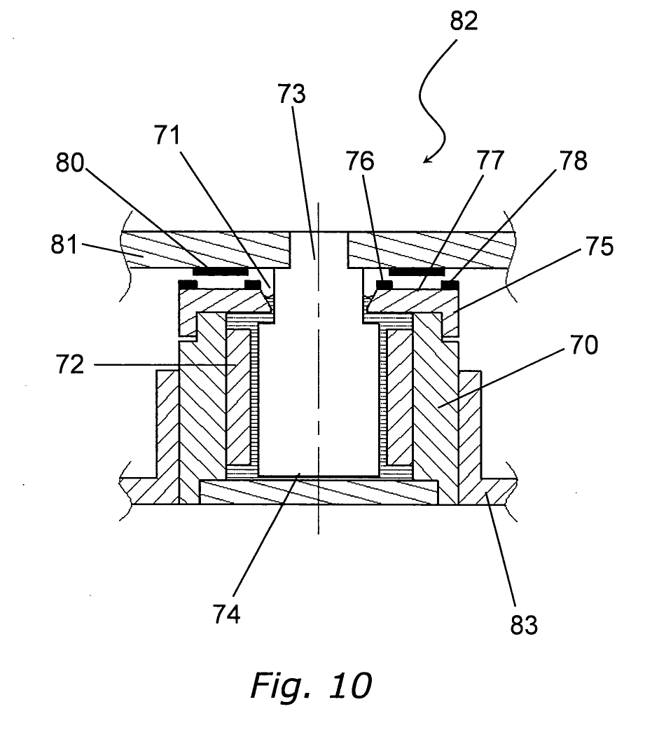

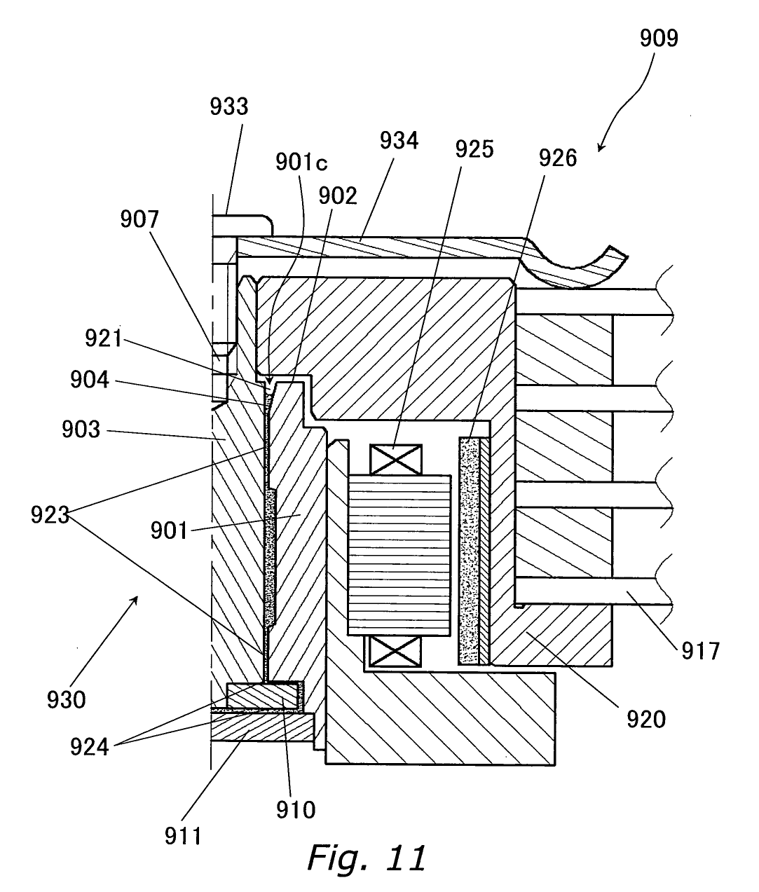

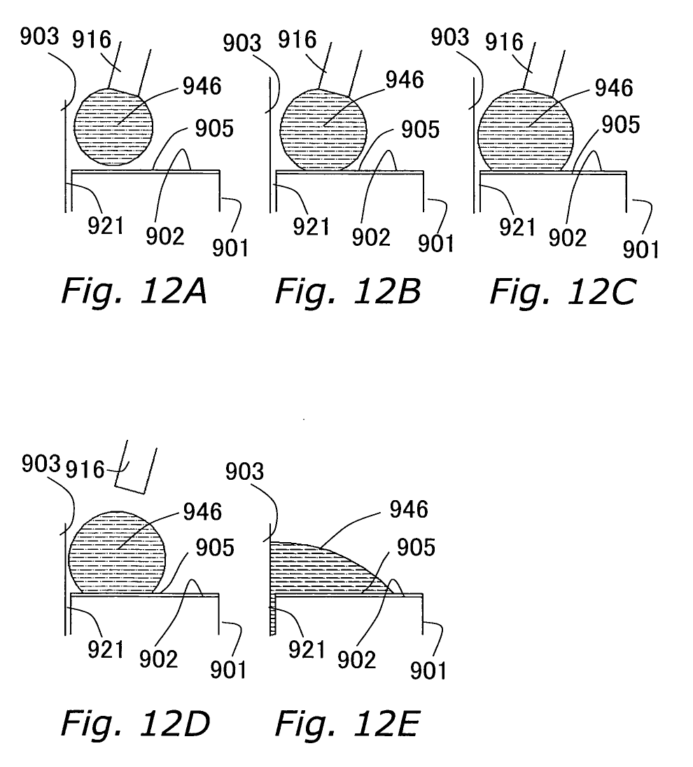

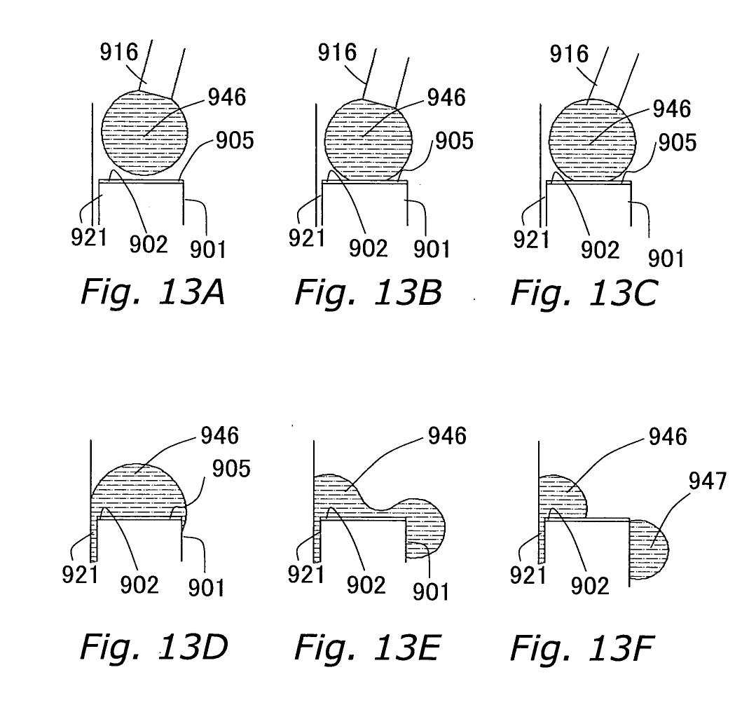

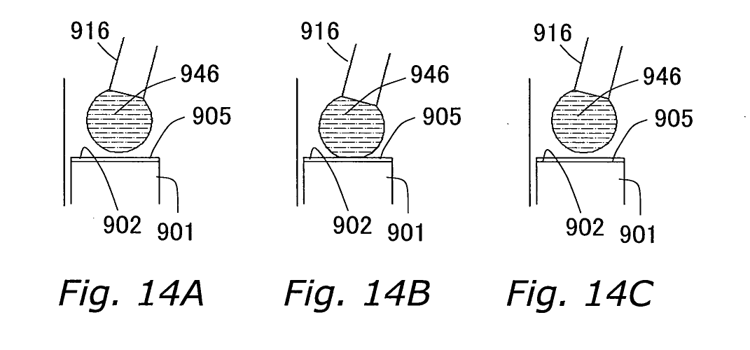

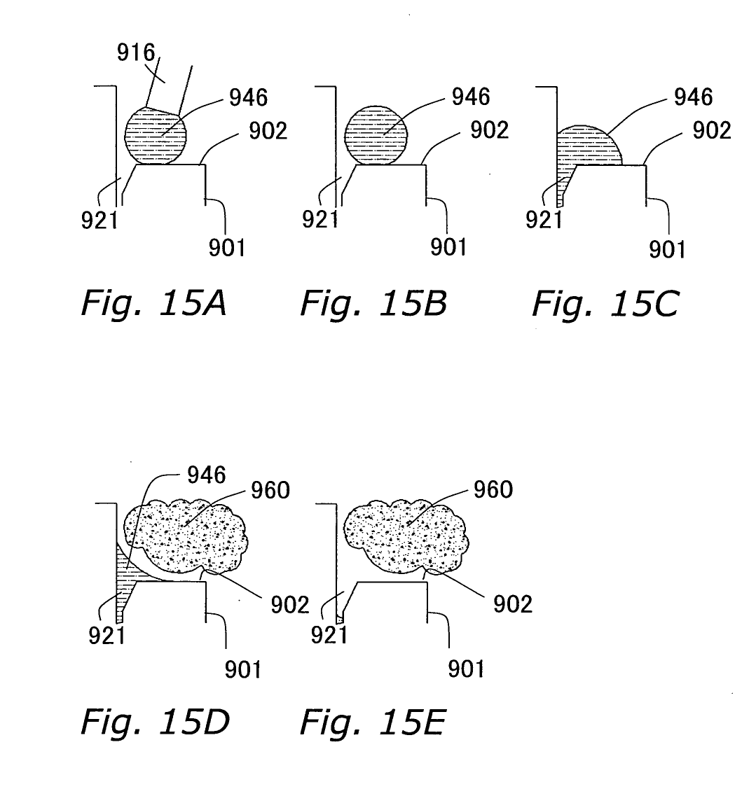

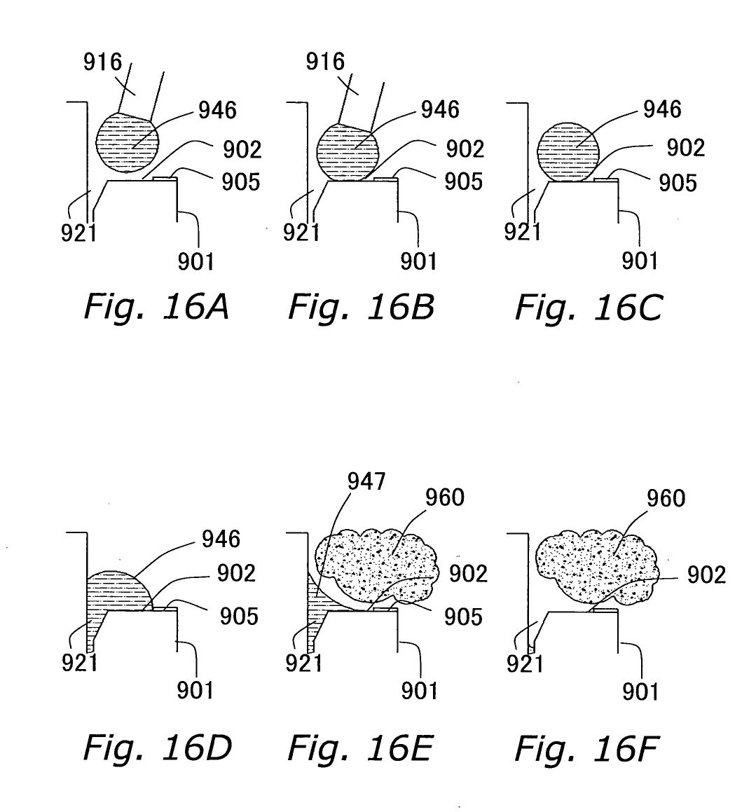

For example, as shown in FIG. 10, a hydrodynamic bearing device 82 may include a tubular radial metal bearing 72, a thrust bearing portion 74 of a ring shape which is provided at a tip position of a shaft 73, a sleeve holder 70 for fixing the radial metal bearing 72 to a base 83, and a bearing seal portion 71 which is provided on a cover 75 near the bearing opening portion. In this example, an lube repellent application area 76 is provided on an inner peripheral side of the cover 75 and an lube repellent application area 78 is provided on an outer peripheral side. Adjacent to the lube repellent application areas 76 and 78, an lube repellent non application area 77 is provided. To a tip of the shaft 73, a hub 81 is mounted. On an inner peripheral portion of the hub 81, an lube repellent application area 80 is formed. With such a structure, similar effects as those of the first through tenth embodiments can be achieved.

In the spindle motor 9 according to the first embodiment or the like, the shaft 3 rotates, one end of the sleeve 1 is closed, and the stator 25 is located so as to oppose the inner periphery of the rotor magnet 26 having a cylindrical shape. However, the present invention is not limited to such an example. For example, the present invention may also be applied to a structure in which the shaft 3 is fixed to the base 8 or the like, and the sleeve 1 rotates.

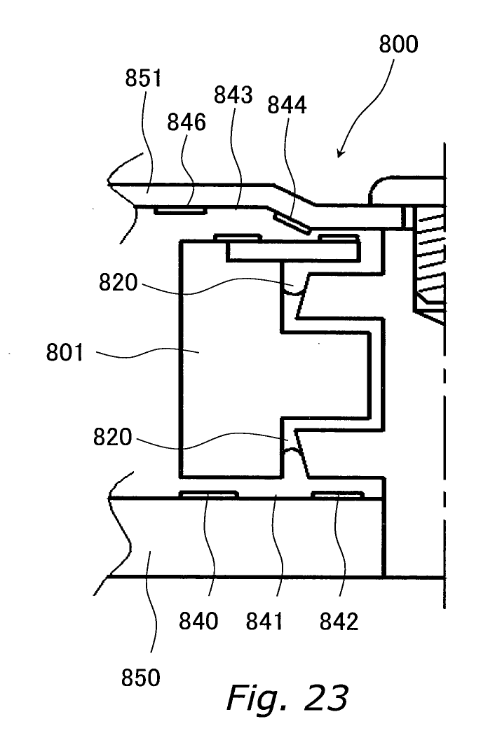

As shown in FIG. 23, for example, the present invention may be applied to a hydrodynamic bearing device 800 having a both-end-open bearing structure in which bearing seal portions 820 are formed on both ends of a sleeve 801. In such a structure, even when lube repellent application areas 840, 842, 844, and 846 and the lube repellent non-application areas 841 and 843 are formed on a base chassis 850 and/or a top cover 851, which are fixed components, similar effects as those of the first through tenth embodiments can be achieved.

Alternatively, a so-called inner rotor type structure, in which the stator 25 is located so as to oppose the outer peripheral surface of the rotor magnet 26, may be employed.

In the seventh embodiment, the first lube repellent application areas 501 and 502 are formed on both the opposing surfaces 1b and 20b of the sleeve 1 and the hub 20. However, the present invention is not limited to such an example.

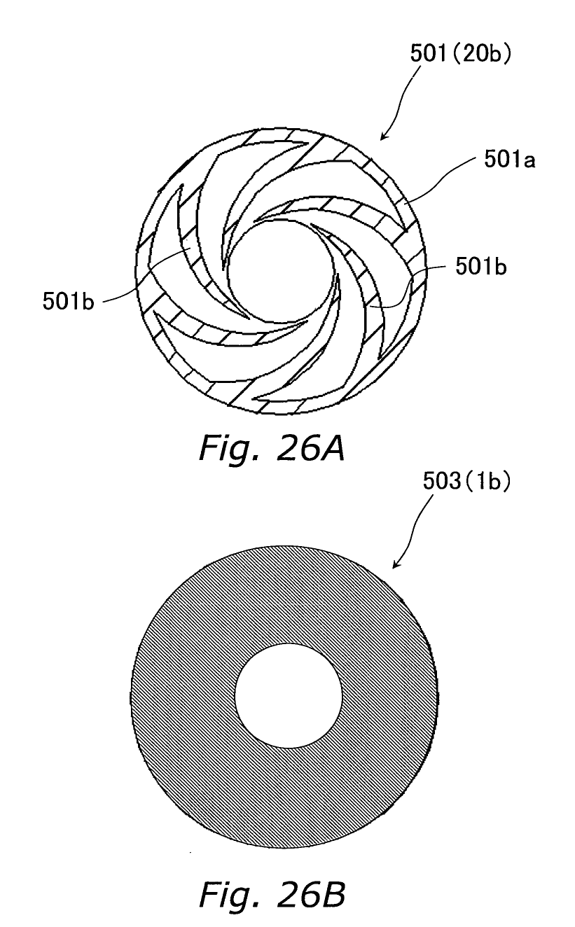

For example, on the opposing surface 20b of the hub which is the rotating member, a first lube repellent application area 501 as shown in FIG. 26A may be formed, and on the opposing surface 1b of the sleeve 1 which is the stationary member, a second lube repellent application area 503 to which the lube repellent 5 is applied entirely as shown in FIG. 26B may be formed. Even with such a structure, effects similar to those as described above can be achieved. FIGS. 26A and 26B are both plan views viewed from the surface to which the lube repellent 5 is applied.

In the seventh embodiment, the raking portions 501b and 502b of the first lube repellent application areas 501 and 502 are formed into a so-called spiral pattern. However, the present invention is not limited to such an example.

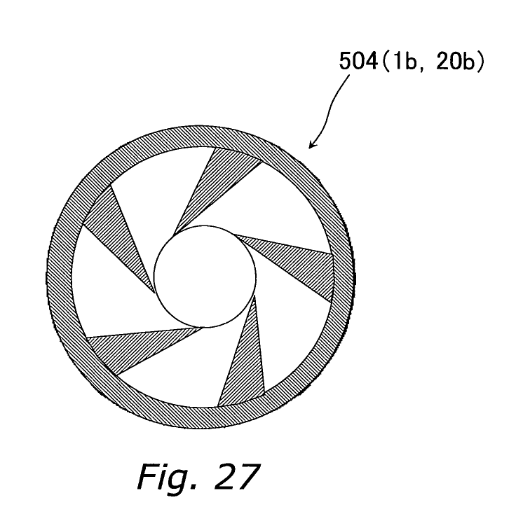

The pattern of the raking portions may be any pattern as long as they can rake the lubricant toward the rotational axis center as the hub rotates. For example, an lube repellent area 504 having a radial pattern as shown in FIG. 27 may be employed.

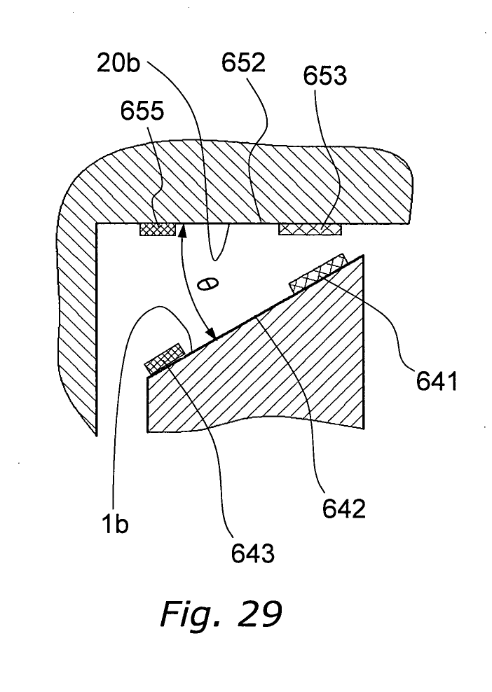

In most of the first through tenth embodiments, the opposing surfaces of the shaft and the sleeve are parallel to each other, or oppose to the axial direction of the shaft. However, the present invention is not limited to such an example. For example, as shown in FIG. 29, the opposing surface 1b may be formed so as to be inclined with respect to the opposing surface 20b by angle θ (θ<90°), and lube repellent application areas 641, 643, 653, and 655 and lube repellent non-application areas 642 and 652 may be provided as shown in FIG. 29. Further, both the opposing surface 1b and the opposing surface 20b may be parallel or inclined with respect to the central axis.

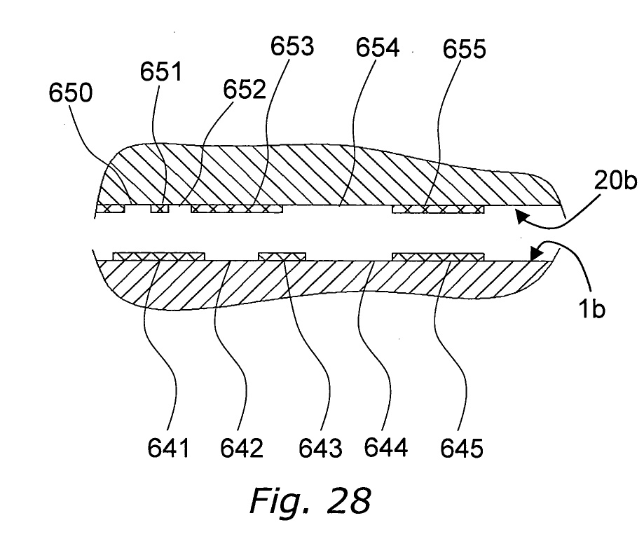

In the fifth embodiment, the lube repellent application areas of the rotating member and the fixed member oppose each other. In the sixth embodiment, the lube repellent application areas and the lube repellent non-application areas oppose each other. These conditions may be satisfied at the same time. For example, as shown in FIG. 28, an lube repellent application area 641 on the opposing surface 1b of the sleeve 1 opposes lube repellent application areas 651 and 653 and lube repellent non-application areas 650 and 652 on the opposing surface 20b of the hub 20. An lube repellent non-application area 644 on the opposing surface 1b opposes an lube repellent non-application area 654 on the opposing surface 20b. An lube repellent application area 645 on the opposing surface 1b opposes the lube repellent application area 655 on the opposing surface 20b. With such a structure having features of both the fifth and sixth embodiments, the lube repellent can be prevented from dispersing.

Further, in order to clearly show that the lube repellent has been applied, the lube repellent may be mixed with carbon black, fluorescing agent or the like before application. After the lube repellent is cured, portions where the lube repellent is applied can be readily identified by irradiating with a normal light source, a black light, or the like. In this way, a mistake in the position to supply the lubricant can be avoided, and it is ensured that the lubricant is prevented from spilling out of the sleeve.

In the first through tenth embodiments, the spindle motor for hard disc drives have been described as an example. However, the present invention is not limited to such an example. The present invention may also be applied to, for example, a spindle motor for an optical disc drive, a polygon mirror spindle motor incorporated into a laser beam printer or the like, a motor for a rotational head device of a video tape recorder, and the like.

According to the present invention, a lubricant of a necessary amount can be supplied to a bearing clearance stably and without tainting other components. Thus, the present invention can be widely applied to hydrodynamic bearing devices in information recording and reproduction apparatuses such as hard disc drives, optical disc apparatuses, video tape recorders and the like. Furthermore, the present invention can also be used in other types of hydrodynamic bearing devices which support rotational portions.

What is claimed is:

1. A hydrodynamic bearing device, comprising:
a sleeve having an opening portion as a bearing hole on at least one end;
a shaft which is inserted into the bearing hole of the sleeve and is supported so as to be relatively rotatable with respect to the sleeve;
a lubricant interposed in a clearance between the sleeve and the shaft;
a plurality of lube repellent application areas which are formed into a circular pattern with the shaft being a substantial center on at least one of the sleeve and the shaft at positions outside a liquid-gas interface between the lubricant and air in a radial direction or in an axial direction; and
a lube repellent non-application area formed between two of the lube repellent application areas which are adjacent to each other.

2. A hydrodynamic bearing device according to claim 1, wherein a surface roughness of the lube repellent non-application area is larger than a surface roughness of the lube repellent application areas.

3. A hydrodynamic bearing device according to claim 1, wherein the lube repellent application areas are provided near the opening portion of the sleeve and near an outer end portion in the radial direction.

4. A hydrodynamic bearing device according to claim 1, wherein the shaft includes a fixed portion which is fixed or integrally formed.

5. A hydrodynamic bearing device according to claim 1, wherein the lube repellent application areas and the lube repellent non-application area are provided on one of the sleeve and the shaft which rotates.

6. A hydrodynamic bearing device according to claim 1, wherein the lube repellent application areas and the lube repellent non-application area are provided on both of the sleeve and the shaft.

7. A hydrodynamic bearing device according to claim 1, wherein the lube repellent application areas and the lube repellent non-application area are formed on opposing surfaces of the sleeve and the shaft which oppose each other.

8. A hydrodynamic bearing device according to claim 7, wherein the lube repellent non-application area is formed on a surface opposing the lube repellent application areas which is formed on one of the shaft and the sleeve, and the lube repellent non-application area is formed on a surface opposing the lube repellent application areas which is formed on the other of the shaft and the sleeve.

9. A hydrodynamic bearing device according to claim 8, wherein the lube repellent application area which is formed on the one of the shaft and the sleeve and the lube repellent application area adjacent to the lube repellent non-application area located on the surface opposing the lube repellent application area have an overlapping portion which overlaps each other in a direction along the opposing surface.

10. A hydrodynamic bearing device according to claim 7, wherein the lube repellent application areas is formed on a surface opposing the lube repellent application areas which is formed on one of the shaft and the sleeve, and the lube repellent non-application area is formed on a surface opposing the lube repellent non-application area.

11. A hydrodynamic bearing device according to claim 10, wherein a clearance between two of the opposing lube repellent application areas which are located at a position closer to the outside than the lube repellent non-application areas from the opening portion is formed so as to be narrower than a clearance between the opposing lube repellent non-application areas.

12. A spindle motor comprising a hydrodynamic bearing device according to claim 1.

13. An information recording and reproducing apparatus, comprising:
a recording medium;
a head for recording and reproducing information on and from the recording medium; and
a spindle motor according to claim 12 which drives the recording medium or the head to rotation.

14. A hydrodynamic bearing device, comprising:
a sleeve having an opening portion as a bearing hole on at least one end;
a shaft which is inserted into the bearing hole of the sleeve and is supported so as to be relatively rotatable with respect to the sleeve;
a lubricant interposed in a clearance between the sleeve and the shaft; and
a first lube repellent application area which includes a circular portion to which an lube repellent is applied in a ring shape with the shaft being a substantial center and a raking portion to which the lube repellent is continuously applied at a position inside the circular portion in a pattern extending toward inside the bearing hole along a direction opposite to the direction of the relative rotation, and which is formed at least on a rotating one of opposing surfaces of the shaft and the sleeve which oppose each other.

15. A hydrodynamic bearing device according to claim 14, wherein:
the first lube repellent area is formed on the rotating one of the opposing surfaces; and
a second lube repellent application area to which the lube repellent is applied entirely across a surface is further provided on the other of the opposing surfaces, which is a fixed one.

16. A hydrodynamic bearing device according to claim 14, wherein the shaft includes a fixed portion which is fixed or integrally formed.

17. A spindle motor comprising a hydrodynamic bearing device according to claim 14.

18. An information recording and reproducing apparatus, comprising:
a recording medium;
a head for recording and reproducing information on and from the recording medium; and
a spindle motor according to claim 17 which drives the recording medium or the head to rotation.

19. A hydrodynamic bearing device, comprising:
a sleeve having an opening portion as a bearing hole on at least one end;
a shaft which is inserted into the bearing hole of the sleeve and is supported so as to be relatively rotatable with respect to the sleeve;
a lubricant interposed in a clearance between the sleeve and the shaft; and
a plurality of first areas which are formed into a circular pattern with the shaft being a substantial center on at least one of the sleeve and the shaft at positions outside a liquid-gas interface between the lubricant and air in a radial direction or in an axial direction; and
at least one second area which is formed between two of the first areas adjacent to each other and has a surface roughness larger than that of the first areas.

20. A hydrodynamic bearing device according to claim 19, wherein an lube repellent is applied to the first areas.

21. A spindle motor comprising a hydrodynamic bearing device according to claim 19.

22. An information recording and reproducing apparatus, comprising:
a recording medium;
a head for recording and reproducing information on and from the recording medium; and
a spindle motor according to claim 21 which drives the recording medium or the head to rotation.

23. A hydrodynamic bearing device, comprising:
a shaft;
a sleeve having a bearing hole into which the shaft is inserted so as to be relatively rotatable, which has one end being closed;
a lubricant filled in a clearance formed between the sleeve and the shaft;
a bearing portion which supports the sleeve and the shaft in a radial direction and an axial direction of the shaft with the lubricant;
a cover which is located to face an end surface of an open end of the sleeve and which has at least one opening formed near the shaft, a lubricant reservoir formed in a space formed together with the sleeve; and at least one vent hole for communicating the lubricant reservoir and the outside of the bearing portion;
an inner lube repellent application area formed into a ring pattern with the shaft being a substantial center on a surface of the cover which is further from the bearing portion at a position closer to the shaft than the vent hole in the radial direction;
an outer lube repellent application area formed into a ring pattern with the shaft being a substantial center on the surface of the cover which is further from the bearing portion at a position further from the shaft than the vent hole in the radial direction; and
an lube repellent non-application area which is formed between the inner lube repellent application area and the outer lube repellent application area.

24. A spindle motor comprising a hydrodynamic bearing device according to claim 23.

25. An information recording and reproducing apparatus, comprising:
a recording medium;
a head for recording and reproducing information on and from the recording medium; and
a spindle motor according to claim 24 which drives the recording medium or the head to rotation.
